(19) United States
(12) Patent Application Publication
(10) Pub. No.: US 2021/0234167 A1
(43) Pub. Date: Jul. 29, 2021

(54) POROUS GRAPHENE/CARBON COMPOSITE BALLS FOR AN ALKALI METAL BATTERY ANODE

(71) Applicant: Global Graphene Group, Inc., Dayton, OH (US)

(72) Inventors: Aruna Zhamu, Springboro, OH (US); Hui He, Dayton, OH (US); Hao-Hsun Chang, Centerville, OH (US); Bor Z. Jang, Centerville, OH (US)

(21) Appl. No.: 16/773,227

(22) Filed: Jan. 27, 2020

(51) Int. Cl. H01M 4/587; H01M 10/0525; H01M 4/04; H01M 10/0565; H01M 10/054; H01M 4/62; H01M 4/02

(52) U.S. Cl. CPC H01M 4/587; H01M 10/0525; H01M 4/0404; H01M 4/0471; H01M 2004/027; H01M 10/054; H01M 4/62; H01M 2004/021; H01M 10/0565

(57) ABSTRACT

Provided is an anode for a lithium battery or sodium battery, the anode comprising multiple porous graphene composite balls, wherein the porous graphene composite ball comprises a plurality of graphene sheets and an ion-conducting material, at a graphene-to-ion-conducting material weight ratio from 2/98 to 98/2, forming into the ball having a diameter from 100 nm to 20 μm and a pore or multiple pores having a pore volume fraction from 10% to 99.9% based on the total porous graphene composite ball volume.

### FIELD

The present disclosure relates generally to the field of alkali metal battery or alkali metal-ion battery and, more particularly, to a lithium or sodium secondary battery anode having multiple porous graphene composite balls (e.g. porous graphene/carbon balls) and a process for producing the porous graphene composite balls, the electrode and the battery.

### BACKGROUND

Rechargeable lithium-ion (Li-ion) and lithium metal batteries (e.g. Li-sulfur, Li metal-air, and lithium-metal oxide batteries) are considered promising power sources for electric vehicle (EV), hybrid electric vehicle (HEV), and portable electronic devices, such as lap-top computers and mobile phones. Lithium as a metal element has the highest capacity (3,861 mAh/g) compared to any other metal. Hence, in general, Li metal batteries have a significantly higher energy density than lithium ion batteries. Similarly, Na metal batteries have a higher energy than corresponding sodium ion batteries.

Historically, rechargeable lithium metal batteries were produced using non-lithiated compounds, such as TiS₂, MoS₂, MnO₂, CoO₂, and V₂O₅, as the cathode active materials, coupled with a lithium metal anode. When the battery was discharged, lithium ions were transferred from the lithium metal anode through the electrolyte to the cathode, and the cathode became lithiated. Unfortunately, upon repeated charges/discharges, the lithium metal resulted in the formation of dendrites at the anode that ultimately grew to penetrate through the separator, causing internal shorting and explosion. As a result of a series of accidents associated with this problem, the production of these types of secondary batteries was stopped in the early 1990's.

To overcome these safety issues, several alternative approaches were proposed in which either the electrolyte or the anode was modified. The first approach involves replacing Li metal by graphite (a Li insertion material) as the anode. The operation of such a battery involves shuttling Li ions between two Li insertion compounds at the anode and the cathode, respectively; hence, the name “Li-ion battery.” Presumably because of the presence of Li in its ionic rather than metallic state, Li-ion batteries are inherently safer than Li-metal batteries. The second approach entails replacing the liquid electrolyte by a dry polymer electrolyte, leading to the Li solid polymer electrolyte (Li—SPE) batteries. However, Li—SPE has seen very limited applications since it typically requires an operating temperature of up to 80° C. The third approach involves the use of a solid electrolyte that is presumably resistant to dendrite penetration, but the solid electrolyte normally exhibits excessively low lithium-ion conductivity at room temperature. Alternative to this solid electrolyte approach is the use of a rigid solid protective layer between the anode active material layer and the separator layer to stop dendrite penetration, but this typically ceramic material-based layer also has a low ion conductivity and is difficult and expensive to make and to implement in a lithium metal battery. Furthermore, the implementation of such a rigid and brittle layer is incompatible with the current lithium battery manufacturing process and equipment.

Although lithium-ion (Li-ion) batteries are promising energy storage devices for electric drive vehicles, state-of-the-art Li-ion batteries have yet to meet the cost and performance targets. Li-ion cells typically use a lithium transition-metal oxide or phosphate as a positive electrode (cathode) that de/re-intercalates Li⁺ at a high potential with respect to the carbon negative electrode (anode). The specific capacity of graphite anode is <372 mAh/g and that of lithium transition-metal oxide or phosphate based cathode active material is typically in the range from 140-220 mAh/g. As a result, the specific energy of commercially available Li-ion cells is typically in the range from 120-240 Wh/kg, most typically 150-220 Wh/kg. These specific energy values are significantly lower than what would be required for battery-powered electric vehicles to be widely accepted.

With the rapid development of hybrid (HEV), plug-in hybrid electric vehicles (HEV), and all-battery electric vehicles (EV), there is an urgent need for anode and cathode materials that provide a rechargeable battery with a significantly higher specific energy, higher energy density, higher rate capability, long cycle life, and safety. Among various advanced energy storage devices, alkali metal batteries, including Li-air (or Li—O₂), Na-air (or Na—O₂), Li—S, and Na—S batteries, are especially attractive due to their high specific energies.

The Li—O₂ battery is possibly the highest energy density electrochemical cell that can be configured today. The Li—O₂ cell has a theoretic energy density of 5.2 kWh/kg when oxygen mass is accounted for. A well configured Li—O₂ battery can achieve an energy density of 3,000 Wh/kg, 15-20 times greater than those of Li-ion batteries. However, current Li—O₂ batteries still suffer from poor energy efficiency, poor cycle efficiency, and dendrite formation and penetration issues.

One of the most promising energy storage devices is the lithium metal anode based battery, such as lithium-sulfur (Li—S) cell, since the theoretical capacity of Li is 3,861 mAh/g and that of S is 1,675 mAh/g. In its simplest form, a Li—S cell consists of elemental sulfur as the positive electrode and lithium as the negative electrode. The lithium-sulfur cell operates with a redox couple, described by the reaction S₈+16Li↔8Li₂S that lies near 2.2 V with respect to Li⁺/Li^{o}. This electrochemical potential is approximately ⅔ of that exhibited by conventional positive electrodes (e.g. LiMnO₄). However, this shortcoming is offset by the very high theoretical capacities of both Li and S. Thus, compared with conventional intercalation-based Li-ion batteries, Li—S cells have the opportunity to provide a significantly higher energy density (a product of capacity and voltage). Assuming complete reaction to Li₂S, energy densities values can approach 2,500 Wh/kg and 2,800 Wh/l, respectively, based on the combined Li and S weights or volumes. If based on the total cell weight or volume, the energy densities can reach approximately 1,000 Wh/kg and 1,100 Wh/l, respectively. However, the current Li-sulfur cells reported by industry leaders in sulfur cathode technology have a maximum cell specific energy of 250-350 Wh/kg (based on the total cell weight), which is far below what is possible.

In summary, despite its great potential, the practical realization of the Li—S battery has been hindered by several obstacles, such as dendrite-induced internal shorting, low active material utilization efficiency, high internal resistance, self-discharge, and rapid capacity fading on cycling. These technical barriers are due to the poor electrical conductivity of elemental sulfur, the high solubility of lithium polysulfides in organic electrolyte (which migrate to the anode side, resulting in the formation of inactivated Li₂S in the anode), and Li dendrite formation and penetration. The most serious problems of Li metal secondary (rechargeable) batteries (including all sorts of cathode active materials, such as S, Se, NCM, NCM, other lithium transition metal oxide, sodium-transition metal oxide, etc.) remains to be the dendrite formation and penetration, high solid-electrolyte interfacial impedance, and poor cycle life. Sodium metal batteries have similar problems to address.

Furthermore, it has been challenging and expensive to deposit or attach a layer of lithium metal (or sodium metal) on surfaces of an anode current collector (Cu foil). There is a need to reduce the amount of lithium metal or sodium metal in the anode of a lithium metal or sodium metal battery. It would be desirable and preferable if the presence of a lithium or sodium metal layer (film, foil, or coating) is eliminated initially when the cell is made. The lithium metal or sodium metal is then supplied from the cathode side (e.g. from lithium transition metal oxide or sodium transition metal oxide) during the subsequent battery charging operations.

It is an object of the present disclosure to overcome most of the afore-mentioned problems associated with current lithium metal batteries or sodium metal batteries. A specific object of the present disclosure is to provide porous graphene composite ball-based anode of a lithium metal and sodium metal secondary battery that exhibits a long and stable charge-discharge cycle life without suffering from lithium or sodium dendrite problems.

### SUMMARY

The present disclosure provides an anode electrode (also simply referred to as an anode) for an alkali metal battery (lithium or sodium metal battery or combined Li/Na metal batteries) and a process for producing such an anode. The disclosure also provides a lithium metal battery, a sodium metal, or combined Li/Na metal battery containing such an anode electrode.

In certain embodiments, the disclosure provides an anode for a lithium battery (e.g. lithium metal battery and lithium-ion battery) or sodium battery (e.g. sodium metal battery or sodium-ion battery). The anode comprises multiple porous graphene composite balls, wherein the composite ball comprises multiple graphene sheets and an ion-conducting material (a lithium ion-conducting or sodium ion-conducting material, such as carbon) at a graphene-to-ion-conducting material weight ratio from 2/98 to 98/2. Preferably, the porous graphene composite ball comprises a plurality of graphene sheets (preferably each having a length or width from 5 nm to 100 μm) that are packed together to form a porous ball-shaped structure having a diameter from 50 nm to 30 μm and a pore or multiple pores contained therein. In certain embodiments, the graphene sheets are bonded by the ion-conducting material. In some embodiments, the graphene sheets substantially constitute a ball shape that are encapsulated by or coated with a shell of the ion-conducting material. Five illustrative examples of porous graphene composite balls are given as P1, P2, P3, P4, and P5 in FIG. 2(A).

The porous graphene composite ball (also herein referred to as the porous graphene composite particulate) can be substantially spherical, ellipsoidal, elongated, or irregular in shape. The porous graphene composite ball preferably comprises a pore or a plurality of pores having a total pore volume fraction from 10% to 99.9% based on the total graphene composite ball volume.

In some embodiments, the ion-conducting material may comprise carbon and the multiple porous graphene composite balls comprise a graphene/carbon ball comprising a plurality of graphene sheets and a carbon phase that together form the ball-shape structure. The carbon material refers to amorphous carbon, polymeric carbon or carbonized resin, CVD carbon, sputtering carbon, pitch-derived carbon, etc.

In certain embodiments, the ion-conducting material comprises a lithium ion-conducting material selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4. In certain preferred embodiments, this ion-conducting material is dispersed in a carbon matrix or polymer matrix. In some embodiments, this ion-conducting material is coated on the exterior surface of a shell of carbon or ion-conducting polymer that encapsulates a porous core containing multiple graphene sheets and a pore or multiple pores.

In some embodiments, the ion-conducting material contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof. In some embodiments, this ion-conducting material is coated on the exterior surface of a shell of carbon or ion-conducting polymer that encapsulates a porous core containing multiple graphene sheets and a pore or multiple pores.

In certain embodiments, the ion-conducting material comprises a lithium ion-conducting polymer selected from polydially dimethyl-ammonium chloride (PDDA), polysodium 4-styrenesulfonate (PSS), polyethylene glycol tert-octylphenylether (PEGPE), polyallyl amine (PAAm), poly(ethylene oxide) (PEO), polypropylene oxide (PPO), poly(acrylonitrile) (PAN), poly(methyl methacrylate) (PMMA), poly(vinylidene fluoride) (PVdF), poly bis-methoxy ethoxyethoxide-phosphazenex, polyvinyl chloride, polydimethylsiloxane, poly(vinylidene fluoride)-hexafluoropropylene (PVDF-HFP), a sulfonated derivative thereof, or a combination thereof. In some embodiments, this ion-conducting polymer forms a shell that encapsulates a porous core containing multiple graphene sheets and a pore or multiple pores.

The ion-conducting material may comprise a sulfonated polymer, which is found by us to be typically both lithium ion-conducting and sodium ion-conducting.

In certain embodiments, the anode further comprises a current collector having two primary surfaces, wherein the multiple porous graphene composite balls may be deposited on one or two primary surfaces of the current collector. These porous graphene composite balls are then packed, with or without a binder or adhesive, into an anode active material layer.

The graphene sheets contain single-layer or few-layer graphene, wherein the few-layer graphene sheets have 2-10 layers of stacked graphene planes having an inter-plane spacing d₀₀₂ from 0.3354 nm to 0.60 nm as measured by X-ray diffraction and the single-layer or few-layer graphene sheets contain a pristine graphene material having essentially zero % of non-carbon elements, or a non-pristine graphene material having 0.001% to 25% by weight of non-carbon elements.

The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In certain embodiments, the graphene ball or particulate further comprises therein an adhesive, an electron-conducting, or an ion-conducting material (lithium ion-conducting or sodium ion-conducting) as a binder or matrix material that helps to hold multiple graphene sheets in a ball together or to provide additional transport channels for lithium or sodium ions, if so desired. The electron-conducting material may be selected from an intrinsically conducting polymer, a carbon (e.g. amorphous carbon, polymeric carbon or carbonized resin, carbonized pitch, CVD carbon, sputtering carbon, etc.), a pitch material, a metal, or a combination thereof.

The intrinsically conducting polymer is preferably selected from (but not limited to) polyaniline, polypyrrole, polythiophene, polyfuran, polyacetylene, a bi-cyclic polymer, a sulfonated derivative thereof, or a combination thereof.

The lithium ion-conducting material may be selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

In certain embodiments, the lithium ion-conducting material in the graphene ball contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

In some embodiments, the ion-conducting material comprises a lithium ion-conducting polymer selected from polydially dimethyl-ammonium chloride (PDDA), polysodium 4-styrenesulfonate (PSS), polyethylene glycol tert-octylphenylether (PEGPE; C₁₄H₂₂O(C₂H₄O)ₙ, n=9-10), polyallyl amine (PAAm; (C₃H₅NH₂)ₙ), poly(ethylene oxide) (PEO), polypropylene oxide (PPO), poly(acrylonitrile) (PAN), poly(methyl methacrylate) (PMMA), poly(vinylidene fluoride) (PVdF), poly bis-methoxy ethoxyethoxide-phosphazenex, polyvinyl chloride, polydimethylsiloxane, poly(vinylidene fluoride)-hexafluoropropylene (PVDF-HFP), a sulfonated derivative thereof, or a combination thereof. In some embodiments, the lithium ion-conducting material in the graphene ball comprises a sulfonated polymer, which is typically conductive to lithium ions or sodium ions.

The porous graphene composite ball or particulate may further contain an electron-conducting material, disposed therein, selected from expanded graphite flake, carbon nanotube, carbon nano-fiber, carbon fiber, carbon particle, graphite particle, carbon black, acetylene black, pitch, an electron-conducting polymer, or a combination thereof. The electron-conducting polymer may be selected from (but not limited to) polyaniline, polypyrrole, polythiophene, polyfuran, polyacetylene, a bi-cyclic polymer, a sulfonated derivative thereof, or a combination thereof. Any intrinsically conductive polymer may be used for this purpose.

The graphene composite ball may be pre-loaded with lithium or sodium metal (impregnated into the core of the particulate) before the battery is made. Alternatively, the anode of the intended alkali metal battery contains a lithium source or a sodium source, in addition to the graphene balls. The lithium source is preferably selected from foil, particles, or filaments of lithium metal or lithium alloy having no less than 80% by weight of lithium element in the lithium alloy. The sodium source is preferably selected from foil, particles, or filaments of sodium metal or sodium alloy having no less than 80% by weight of sodium element in the sodium alloy.

In the lithium or sodium metal battery, each cell contains an anode layer, as disclosed herein, comprising the graphene balls which are pre-loaded with lithium or sodium or accompanied by a layer of Li or Na ion source. When the battery is discharged, lithium or sodium ions are released from the particulates or the Li or Na ion source and moved through an electrolyte/separator to the cathode comprising a cathode active material layer. The graphene particulates may help to accommodate some lithium or sodium when the battery is subsequently recharged.

In some embodiments, the lithium or sodium metal battery further comprises a separator and a discrete layer of anode current collector (e.g. Cu foil) in contact with the disclosed anode. Multiple graphene balls, along with an optional binder, may be uniformly mixed together to form a single layer or two layers that are bonded to one or two primary surfaces of an anode current collector. Typically, there is a separate, discrete cathode current collector (e.g. Al foil) in contact with the cathode active material layer (containing cathode active material, such as MoS₂, TiO₂, V₂O₅, LiV₃O₈, S, Se, metal polysulfide, NCM, NCA, or other lithium transition metal oxides, etc.), which is supported by (or coated on) the Al foil.

In some embodiments, the anode of the lithium cell or sodium cell comprises the presently disclosed anode of graphene balls, but without the presence of a lithium or sodium metal layer (no particle, film, foil, or coating of Li or Na metal) when the cell is made. The lithium metal or sodium metal is then supplied from the cathode side (e.g. lithium transition metal oxide or sodium transition metal oxide) during the first and subsequent battery charging operations. This avoids the need to deal with lithium metal or sodium metal (highly sensitive to oxygen and moisture in the room air) during battery fabrication. It is challenging and expensive to handle lithium or sodium metal in a manufacturing facility.

In some embodiments, the graphene particulate or ball has a density from 0.05 to 1.7 g/cm³ and a specific surface area from 50 to 2,630 m²/g. In certain embodiments, the particulate, when measured without other ingredients, has a density from 0.1 to 1.7 g/cm³ and has some pores with an average pore size from 2 nm to 10 μm. In some embodiments, the particulate has a physical density higher than 0.8 g/cm³ and a specific surface area greater than 600 m²/g. In some embodiments, the graphene particulate has a physical density higher than 1.0 g/cm³ and a specific surface area greater than 300 m²/g.

The graphene sheets in the ball may comprise a non-pristine graphene material having a content of non-carbon elements in the range from 0.01% to 20% by weight and the non-carbon elements include an element selected from oxygen, fluorine, chlorine, bromine, iodine, nitrogen, hydrogen, or boron.

In certain embodiments, the alkali metal battery comprises a cathode, an anode containing the disclosed multiple graphene balls, an optional lithium source or a sodium source in ionic contact with the anode, and an electrolyte in ionic contact with both the cathode and the anode. The lithium source may be selected from foil, particles, or filaments of lithium metal or lithium alloy having no less than 80% by weight of lithium element in the lithium alloy; or the sodium source is selected from foil, particles, or filaments of sodium metal or sodium alloy having no less than 80% by weight of sodium element in the sodium alloy.

The alkali metal battery may be a lithium metal battery, lithium-sulfur battery, lithium-selenium battery, lithium-air battery, sodium metal battery, sodium-sulfur battery, sodium-selenium battery, or sodium-air battery.

The present disclosure also provides a process for producing the aforementioned anode. In certain embodiments, the process comprises: (a) providing and dispersing multiple porous graphene composite balls and an optional binder or adhesive in a liquid medium to form a slurry;

and (b) dispensing and depositing the slurry onto a surface of a current collector and removing the liquid medium to form the anode.

In certain embodiments of this disclosure, Step (a) of the process may comprise a procedure of depositing a coating of an ion-conducting material onto exterior surfaces of multiple porous graphene balls to obtain the porous graphene composite balls. The procedure of depositing a coating may comprise a procedure selected from melt dipping, solution deposition, chemical vapor deposition, physical vapor deposition, sputtering, electrochemical deposition, spray coating, spray-drying, vibration nozzle coating, pan coating, air-suspension coating, plasma coating, or a combination thereof.

In some embodiments, the porous graphene composite balls in Step (a) are produced from a procedure selected from ball milling, spray drying, pan-coating, air-suspension coating, centrifugal extrusion, vibration nozzle coating, or in-situ polymerization.

In certain preferred embodiments, Step (a) in the disclosed process comprises procedures of (i) producing multiple composite particles each comprising a precursor polymer and an optional carbon or graphite filler dispersed in the precursor polymer, wherein the carbon/graphite filler is selected from graphene sheets, expanded graphite flakes, carbon nanotubes, carbon nano-fibers, carbon fibers, carbon particles, graphite particles, carbon black, acetylene black, pitch, or a combination thereof; (ii) heat-treating the multiple composite particles at least at a temperature selected from 300° C. to 3,200° C. to obtain a porous carbon core for each composite particle; and (iii) encapsulating each composite particle with multiple graphene sheets before or after step (ii) or with an ion-conducting material after step (ii).

The ion-conducting material in the encapsulating shell may comprise carbon (e.g.

amorphous carbon, polymeric carbon or carbonized resin, pitch, CVD carbon, etc.) and/or a lithium ion-conducting polymer selected from polydially dimethyl-ammonium chloride (PDDA), polysodium 4-styrenesulfonate (PSS), polyethylene glycol tert-octylphenylether (PEGPE), polyallyl amine (PAAm), poly(ethylene oxide) (PEO), polypropylene oxide (PPO), poly(acrylonitrile) (PAN), poly(methyl methacrylate) (PMMA), poly(vinylidene fluoride) (PVdF), poly bis-methoxy ethoxyethoxide-phosphazenex, polyvinyl chloride, polydimethylsiloxane, poly(vinylidene fluoride)-hexafluoropropylene (PVDF-HFP), a sulfonated derivative thereof, or a combination thereof.

In some embodiments, Step (a) of the process comprises the procedures of (i) encapsulating multiple particles of a sacrificial material with multiple graphene sheets to produce graphene-embraced sacrificial particles; (ii) partially or completely removing the sacrificial material from the graphene-embraced sacrificial particles to form porous graphene balls, wherein at least a porous graphene ball comprises a graphene shell encapsulating a porous core, wherein the graphene shell comprises multiple graphene sheets and the porous core comprises one or a plurality of pores; and (iii) coating, encapsulating, or impregnating the porous graphene balls with an ion-conducting material to obtain the porous graphene composite balls.

The multiple particles of sacrificial material may further contain a carbon or graphite filler selected from graphene sheets, expanded graphite flakes, carbon nanotubes, carbon nano-fibers, carbon fibers, carbon particles, graphite particles, carbon black, acetylene black, pitch, or a combination thereof. Step (ii) of removing the sacrificial material may be conducted by a procedure of (a) dissolving the sacrificial material using a solvent or water, (b) melting the sacrificial material and allowing the sacrificial material melt to flow out of the encapsulating shell, or (c) burning off the sacrificial material.

In certain preferred embodiments, Step (a) comprises procedures of (i) mixing multiple graphene sheets and an optional carbon or graphite additive with a sacrificial material to produce multiple composite particles comprising graphene sheets and the carbon or graphite additive (filler) dispersed in a matrix of the sacrificial material; (ii) partially or completely removing the sacrificial material from the composite particles to form porous graphene balls; and (iii) coating, encapsulating, or impregnating the porous graphene balls with an ion-conducting material, wherein at least a porous graphene ball comprises an ion-conducting shell encapsulating a porous core, wherein the porous core comprises multiple graphene sheets and one or a plurality of pores (possibly plus some amount of ion-conducting material). The carbon or graphite filler dispersed in the sacrificial material is selected from expanded graphite flakes, carbon nanotubes, carbon nano-fibers, carbon fibers, carbon particles, graphite particles, carbon black, acetylene black, pitch, or a combination thereof. Step (ii) of removing the sacrificial material may be conducted by a procedure of (a) dissolving the sacrificial material using a solvent or water, (b) melting the sacrificial material and allowing the sacrificial material melt to flow out of the encapsulating shell, or (c) burning off the sacrificial material.

The sacrificial material may be selected from a water-soluble polymer, an organic solvent-soluble polymer, a low-melting metal having a melting point lower than 500° C., a water-soluble material, a low-melting organic material having a melting point lower than 200° C., an inorganic material that can be dissolved in a solvent, a composite material, or a combination thereof.

The water-soluble polymer used in the process may be selected from polyvinyl alcohol, polyacrylamide (PAM), polyacrylic acid (PAA), polyamines, polyethyleneimines, polyvinylpyrrolidone (PVP), polyethylene oxide, polyethylene glycol, polypropylene oxide, polypropylene glycol, a copolymer thereof, or a combination thereof.

In certain embodiments, Step (a) of providing porous graphene composite balls comprises (i) preparing a graphene dispersion having multiple sheets of a starting graphene material dispersed in a liquid medium, wherein the starting graphene material is selected from a pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein said dispersion contains a blowing agent having a blowing agent-to-graphene material weight ratio from 0/1.0 to 1.0/1.0; (ii) dispensing, forming and drying the graphene dispersion into multiple droplets containing therein graphene sheets and the blowing agent; and (iii) heat treating the droplets at a heat treatment temperature selected from 80° C. to 3,200° C. at a desired heating rate sufficient to induce volatile gas molecules from non-carbon elements in the graphene material or to activate the blowing agent for producing multiple porous graphene balls.

In some embodiments, the process further comprises a sub-step (iv) of encapsulating the multiple porous graphene balls with an ion-conducting material to obtain the desired porous graphene composite balls.

In some embodiments, the graphene dispersion in sub-step (i) further comprises a polymer dissolved or dispersed in the liquid medium and the polymer-to-graphene weight ratio is from 1/100 to 100/1 and sub-step (iii) acts to converts the polymer into a carbon or graphite material.

In some embodiments, the process further comprises a sub-step (iv) of coating the multiple porous graphene balls with a thin encapsulating layer of a polymer or a polymer composite containing a carbonaceous or graphitic material dispersed in or bonded by a polymer to form polymer- or polymer composite-encapsulated porous graphene balls (the porous composite graphene balls), wherein the thin encapsulating layer has a thickness from 1 nm to 5 μm. This sub-step may be followed by a sub-step of heat-treating the polymer- or polymer composite-encapsulated porous graphene particulates to obtain carbon- or carbon composite-encapsulated porous graphene particulates.

In the disclosed process, the step of dispensing, forming and drying includes operating a procedure selected from pan-coating, air-suspension coating, centrifugal extrusion, vibration-nozzle encapsulation, spray-drying, coacervation-phase separation, interfacial polycondensation and interfacial cross-linking, in-situ polymerization, matrix polymerization, or a combination thereof.

In certain embodiments, the process further comprises a step of impregnating lithium metal or sodium metal into the anode to form lithium-preloaded or sodium-preloaded anode, wherein the lithium metal or sodium metal is preferably lodged in the pores of the composite balls.

The process may further comprise a step of incorporating the anode in a lithium metal battery, lithium-sulfur battery, lithium-selenium battery, lithium-air battery, sodium metal battery, sodium-sulfur battery, sodium-selenium battery, or sodium-air battery.

In Step (a), porous graphene balls may be obtained via several procedures. One example, as discussed above, entails spray-drying of a suspension containing multiple graphene sheets and other optional ingredients dispersed in a liquid medium (e.g. water or organic solvent).

A second example entails ball milling of a mixture containing multiple graphene sheets, a sacrificial material (e.g. sugar, salt, water-soluble polymer, etc.), and optional conducting additive. These graphene sheets can contain pristine graphene, graphene oxide, graphene fluoride, graphene chloride, graphene bromide, graphene iodide, hydrogenated graphene, nitrogenated graphene, chemically functionalized graphene, or a combination thereof. These types of isolated/separated graphene sheets (e.g. individual graphene oxide sheets have been exfoliated and isolated/separated from the precursor graphite oxide materials) can be produced via known processes.

The ball milling procedure of combining separated graphene sheets and a sacrificial material into graphene balls may be preferably conducted by using an energy impacting apparatus selected from a double cone mixer, double cone blender, vibratory ball mill, planetary ball mill, high energy mill, basket mill, agitator ball mill, cryogenic ball mill, micro ball mill, tumbler ball mill, attritor, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer. In certain preferred embodiments, the procedure of operating the energy impacting apparatus is conducted in a continuous manner using a continuous energy impacting device. The milling media may be selected from particles of a metal or metal alloy, a glass, a ceramic, a polymer, or a combination thereof.

Once ball-like structures, comprising graphene sheets and a sacrificial material, are made, the sacrificial material may be partially or totally removed to create voids inside the balls. The resulting porous graphene balls are then encapsulated with a conducting shell. Alternatively, in the cases where the sacrificial material contains a polymer, the ball-like structures may be subjected to carbonization treatments to produce porous graphene composite balls containing graphene sheets being bonded by carbon.

Additionally, there is a unique procedure for producing porous graphene balls directly from graphite without going through the production and separation of graphene sheets first. In other words, separated graphene sheets are not present prior to this unique procedure, in contrast to the procedure in the above-described procedure. This unique process comprises: (A) mixing multiple particles of a graphitic material, multiple polymer carrier particles, and an optional ball-milling media to form a mixture in an impacting chamber of an energy impacting apparatus; (B) operating the energy impacting apparatus with a frequency and an intensity for a length of time sufficient for peeling off graphene sheets from particles of the graphitic material and transferring the graphene sheets to surfaces of the polymer carrier particles to produce graphene-embraced polymer particles inside the impacting chamber; (C) recovering the graphene-embraced polymer particles from the impacting chamber; and (D) pyrolyzing the graphene-embraced polymer particles to thermally convert the polymer into pores and carbon or graphite that bonds the graphene sheets to form porous graphene composite balls, wherein at least a porous graphene ball comprises a graphene/carbon shell encapsulating a porous core and the porous core comprises one or a plurality of pores.

Again, it is important to point out that this unique procedure begins with graphite particles, not previously made isolated/separated graphene sheets. However, the ball milling apparatus can be the same. Thus, the ball milling procedure for concurrent peeling of graphene sheets from graphite particles and re-depositing of peeled-off graphene sheets on carrier particle surfaces may be preferably conducted by using an energy impacting apparatus selected from a double cone mixer, double cone blender, vibratory ball mill, planetary ball mill, high energy mill, basket mill, agitator ball mill, cryogenic ball mill, micro ball mill, tumbler ball mill, attritor, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer.

### BRIEF DESCRIPTION OF THE DRAWINGS

FIG. 1 A flow chart showing the most commonly used prior art process for producing highly oxidized graphene sheets that entails chemical oxidation/intercalation, rinsing, and high-temperature exfoliation procedures.

FIG. 2(A) Schematic of 5 illustrative examples of porous graphene composite balls.

FIG. 2(B) A flow chart showing a process for producing an anode comprising a layer of porous graphene composite balls supported on a current collector surface.

FIG. 2(C) A flow chart showing examples of the presently invented process for producing porous graphene composite balls.

FIG. 3 Schematic of an anode according to some embodiments of the present disclosure; the anode active material layer comprising a mixture of multiple graphene balls and an optional conductive filler supported on a current collector primary surface; the opposing primary surface may also be deposited with such a mixture layer.

FIG. 4(A) Schematic of a prior art lithium metal battery cell.

FIG. 4(B) Schematic of a lithium metal or sodium metal battery cell according to some embodiments of the present disclosure, wherein the anode comprises a layer 252 of multiple porous graphene composite balls and a layer of Li or Na film 250 (foil or coating, as a Li or Na ion source). This layer of Li or Na film preferably is totally ionized during the first discharge of the battery.

FIG. 4(C) Schematic of a lithium metal or sodium metal battery cell according to some embodiments of the present disclosure, wherein the anode comprises a layer 252 of multiple porous graphene composite balls (but no Li or Na film). The cathode active materials 234 contain the required Li or Na ions when the battery cell is made.

FIG. 5 A SEM image of porous graphene balls.

FIG. 6 The capacity decay curves of two sodium metal cells: one cell comprising a layer of porous graphene composite balls (supported on a Cu foil) and a sheet of Na foil as the anode active material and NaFePO₄ as the cathode active material, and the other cell containing no porous graphene composite balls.

### DESCRIPTION OF THE PREFERRED EMBODIMENTS

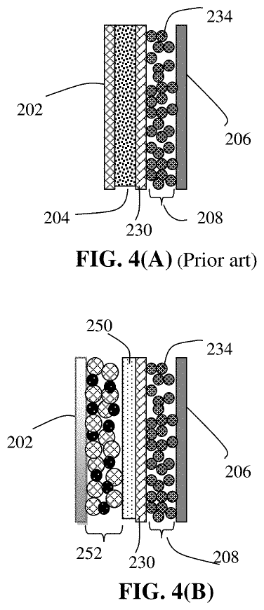

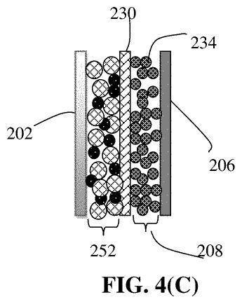

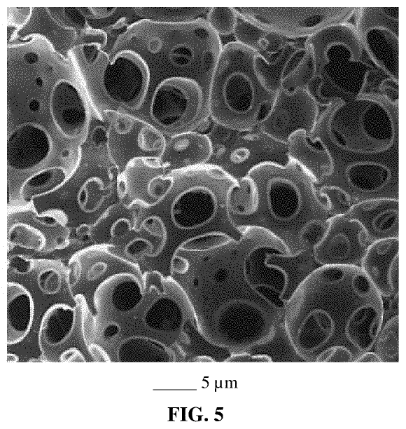

As schematically illustrated in FIG. 4(A), a prior art lithium metal cell is typically composed of an anode current collector 202 (e.g. Cu foil 6-12 μm thick), an anode active material layer 204 (e.g. a foil of lithium metal or lithium-rich metal alloy), a porous separator 230, a cathode active material layer 208 (containing a cathode active material, such as V₂O₅ and MoS₂ particles 234, and conductive additives that are all bonded by a resin binder, not shown), a cathode current collector 206 (e.g. Al foil), and an electrolyte disposed in ionic contact with both the anode active material layer 204 (also simply referred to as the “anode layer”) and the cathode active material layer 208 (or simply “cathode layer”). The entire cell is encased in a protective housing, such as a thin plastic-aluminum foil laminate-based envelop. A prior art sodium metal cell is similarly configured, but the anode active material layer is a foil of sodium metal or sodium-rich metal, or particles of sodium.

The prior art lithium or sodium metal cell is typically made by a process that includes the following steps: (a) The first step is mixing and dispersing particles of the cathode active material (e.g. activated carbon), a conductive filler (e.g. acetylene black), a resin binder (e.g. PVDF) in a solvent (e.g. NMP) to form a cathode slurry; (b) The second step includes coating the cathode slurry on the surface(s) of an Al foil and drying the slurry to form a dried cathode electrode coated on the Al foil; (c) The third step includes laminating a Cu foil (as an anode current collector), a sheet of Li or Na foil (or lithium alloy or sodium alloy foil), a porous separator layer, and a cathode electrode-coated Al foil sheet together to form a 5-layer assembly, which is cut and slit into desired sizes and stacked to form a rectangular structure (as an example of shape) or rolled into a cylindrical cell structure; (d) The rectangular or cylindrical laminated structure is then encased in an aluminum-plastic laminated envelope or steel casing; and (e) A liquid electrolyte is then injected into the laminated structure to make a lithium battery cell.

Due to the high specific capacity of lithium metal and sodium metal, the highest battery energy density can be achieved by alkali metal rechargeable batteries that utilize a lithium metal or sodium metal as the anode active material, provided that a solution to the safety problem can be formulated. These cells include (a) the traditional Li or Na metal battery having a Li insertion or Na insertion compound in the cathode, (b) the Li-air or Na—O₂ cell that uses oxygen, instead of metal oxide, as a cathode (and Li or sodium metal as an anode instead of graphite or hard carbon particles), (c) the Li-sulfur, Na—S, or other cell using a conversion-type cathode active material, and (d) the lithium-selenium cell or sodium-selenium cell.

The Li—O₂ battery is possibly the highest energy density electrochemical cell that can be configured today. The Li—O₂ cell has a theoretic energy density of 5,200 Wh/kg when oxygen mass is accounted for. A well configured Li—O₂ battery can achieve an energy density of 3,000 Wh/kg, which is 15-20 times greater than those of Li-ion batteries. However, current Li—O₂ batteries still suffer from poor energy efficiency, poor cycle efficiency, and dendrite formation issues.

In the Li—S cell, elemental sulfur (S) as a cathode material exhibits a high theoretical Li storage capacity of 1,672 mAh/g. With a Li metal anode, the Li—S battery has a theoretical energy density of ˜1,600 Wh/kg (per total weight of active materials) or ˜500-700 Wh/kg (per total cell weight, including all cell component weights combined). Despite its great potential, the practical realization of the Li—S battery has been hindered by several obstacles, such as low utilization of active material, high internal resistance, self-discharge, and rapid capacity fading on cycling. These technical barriers are due to the poor electrical conductivity of elemental sulfur, the high solubility of lithium polysulfides in organic electrolyte, the formation of inactivated Li₂S, the formation of Li dendrites on the anode, and high solid-electrolyte interfacial impedance at the anode. Despite great efforts worldwide, dendrite formation and high interfacial impedance remain the most critical scientific and technological barriers against widespread implementation of all kinds of high energy density batteries having a Li metal anode. The same problems have also prevented commercial application of sodium metal batteries.

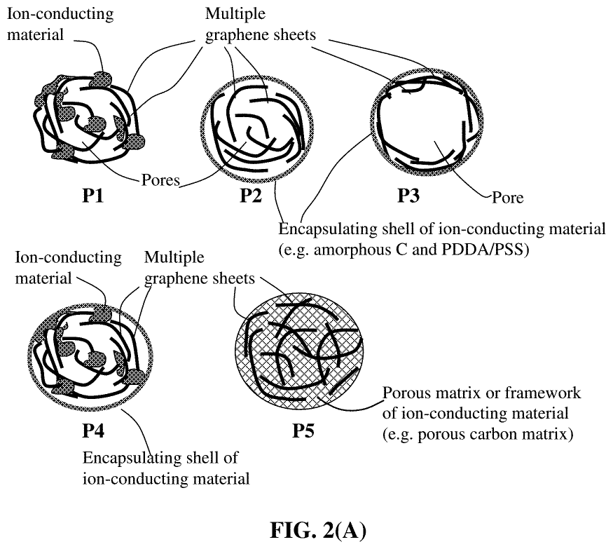

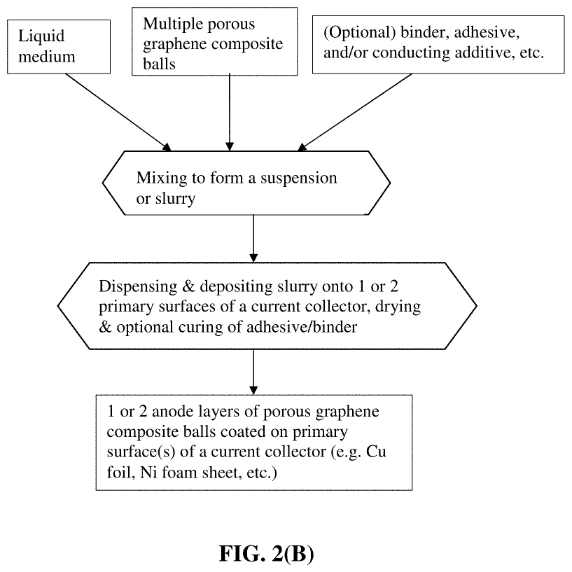

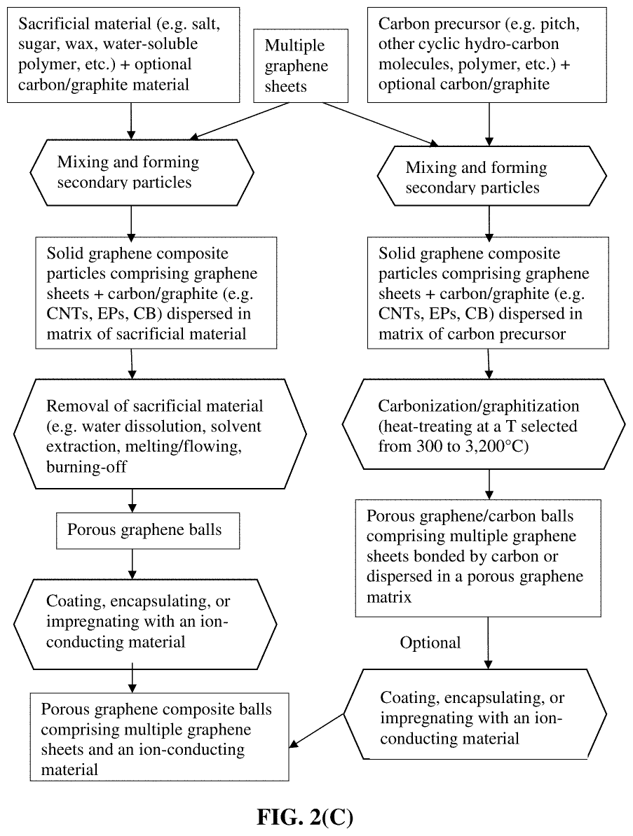

We have discovered a highly dendrite-resistant or dendrite-free, porous graphene composite ball-based anode configuration for a Li metal cell or Na metal cell that exhibits a high energy, high power density, and stable cycling behavior. In certain embodiments, the disclosure provides an anode for a lithium battery or sodium battery, the anode comprising multiple porous graphene composite balls, wherein the porous graphene composite ball comprises a plurality of graphene sheets (preferably each having a length or width from 5 nm to 100 μm) and an ion-conducting material forming into the porous graphene ball having a diameter from 100 nm to 20 μm and a pore or multiple pores. FIG. 2(A) schematically illustrates certain examples of the disclosed porous graphene composite balls.

The porous graphene composite ball (also herein referred to as the porous graphene composite particulate) can be substantially spherical, ellipsoidal, elongated, or irregular in shape. The porous graphene ball preferably comprises a pore or a plurality of pores having a pore volume fraction from 10% to 99.9% based on the total graphene ball volume. The terms “graphene particulates” and “graphene balls” are herein used interchangeably.

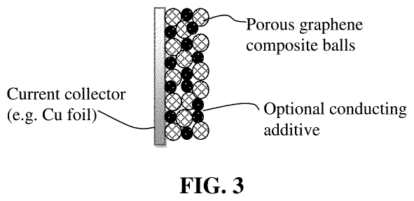

FIG. 3 schematically shows an anode according to some embodiments of the present disclosure wherein the anode active material layer comprises a mixture of multiple graphene composite balls and an optional conductive filler (often bonded by a resin binder, not shown in FIG. 3) supported on a current collector primary surface. The opposing primary surface of the current collector may also be deposited with such a mixture layer.

Schematically shown in FIG. 4(B) is a lithium metal or sodium metal battery cell according to some embodiments of the present disclosure, wherein the anode comprises a layer 252 of a mixture of multiple porous graphene composite balls and a layer of Li or Na film 250 (foil or coating, as a Li or Na ion source). This layer of Li or Na film preferably is totally ionized during the first discharge of the battery. Other components of this battery cell can be similar to those of the conventional lithium or sodium battery.

FIG. 4(C) schematically shows another lithium metal or sodium metal battery cell according to some embodiments of the present disclosure, wherein the anode comprises a layer 252 of multiple graphene composite balls, but no Li or Na film (no extra Li or Na ion source) initially when the cell is made. Instead, the cathode active materials 234 contain the required Li or Na ions when the battery cell is made. This configuration has the advantage that the anode initially contains no lithium or sodium metal film (foil or coating) that is otherwise highly sensitive to moisture and oxygen in the room air and difficult and expensive to handle in a real manufacturing environment.

The layer of porous graphene composites balls may be lithiated (loaded with Li) or sodiated (loaded with Na) before or after the cell is made. For instance, when the cell is made, a foil or particles of lithium or sodium metal (or metal alloy) may be implemented at the anode (e.g. between a layer of multiple porous graphene composite balls and a porous separator or solid electrolyte), as illustrated in FIG. 4(B), to supply this mixture layer of graphene balls/metal particles with lithium or sodium. This lithiation or sodiation procedure can occur when the lithium or sodium foil layer is in close contact with the layer of porous graphene composite balls and a liquid electrolyte is introduced into the anode or the entire cell.

Additionally, during the first battery discharge cycle, lithium (or sodium) is ionized, supplying lithium (or sodium) ions (Li⁺ or Na⁺) into electrolyte. These Li⁺ or Na⁺ ions migrate to the cathode side and get captured by and stored in the cathode active material (e.g. vanadium oxide, MoS₂, S, etc.). During the subsequent re-charge cycle of the battery, Li⁺ or Na⁺ ions are released by the cathode active material and migrate back to the anode. These Li⁺ or Na⁺ ions naturally diffuse into the graphene balls to reach the lithium- or sodium-attracting metal lodged inside the graphene particulates. In this manner, the particulates are said to be lithiated or sodiated.

Graphene is a single-atom thick layer of sp² carbon atoms arranged in a honeycomb-like lattice. Graphene can be readily prepared from graphite, activated carbon, graphite fibers, carbon black, and meso-phase carbon beads. Single-layer graphene and its slightly oxidized version (GO) can have a specific surface area (SSA) as high as 2630 m²/g. It is this high surface area that dramatically reduces the effective electrode current density, which in turn significantly reduces or eliminates the possibility of Li dendrite formation.

However, we have unexpectedly observed that it is difficult for the returning lithium ions or sodium ions (those that return from the cathode back to the anode during battery charge) to uniformly deposit to the underlying Cu foil (current collector) without the presence of porous graphene composite balls. Lithium or sodium has a high tendency to not adhere well to the current collector, thereby becoming isolated lithium or sodium clusters that no longer participate in reversible lithium/sodium storage.

Carbon is known to have five unique crystalline structures, including diamond, fullerene (0-D nano graphitic material), carbon nano-tube or carbon nano-fiber (1-D nano graphitic material), graphene (2-D nano graphitic material), and graphite (3-D graphitic material). The carbon nano-tube (CNT) refers to a tubular structure grown with a single wall or multi-wall. Carbon nano-tubes (CNTs) and carbon nano-fibers (CNFs) have a diameter on the order of a few nanometers to a few hundred nanometers. Their longitudinal, hollow structures impart unique mechanical, electrical and chemical properties to the material. The CNT or CNF is a one-dimensional nano carbon or 1-D nano graphite material.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nano graphene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, and chemically functionalized graphene.

Our research group pioneered the development of graphene materials and related production processes as early as 2002: (1) B. Z. Jang and W. C. Huang, “Nano-scaled Graphene Plates,” U.S. Pat. No. 7,071,258 (Jul. 4, 2006), application submitted on Oct. 21, 2002; (2) B. Z. Jang, et al. “Process for Producing Nano-scaled Graphene Plates,” U.S. patent application Ser. No. 10/858,814 (Jun. 3, 2004) (U.S. Pat. Pub. No. 2005/0271574) (now abandoned); and (3) B. Z. Jang, A. Zhamu, and J. Guo, “Process for Producing Nano-scaled Platelets and Nanocomposites,” U.S. patent application Ser. No. 11/509,424 (Aug. 25, 2006) (U.S. Pat. Pub. No. 2008/0048152) (now abandoned).

Our research group also presented the first review article on various processes for producing NGPs and NGP nanocomposites [Bor Z. Jang and A Zhamu, “Processing of Nano Graphene Platelets (NGPs) and NGP Nanocomposites: A Review,” J. Materials Sci. 43 (2008) 5092-5101]. Four main prior-art approaches have been followed to produce NGPs. The most commonly used process is chemical oxidation and reduction of graphite to produce graphene oxide (GO) and reduced graphene oxide (RGO).

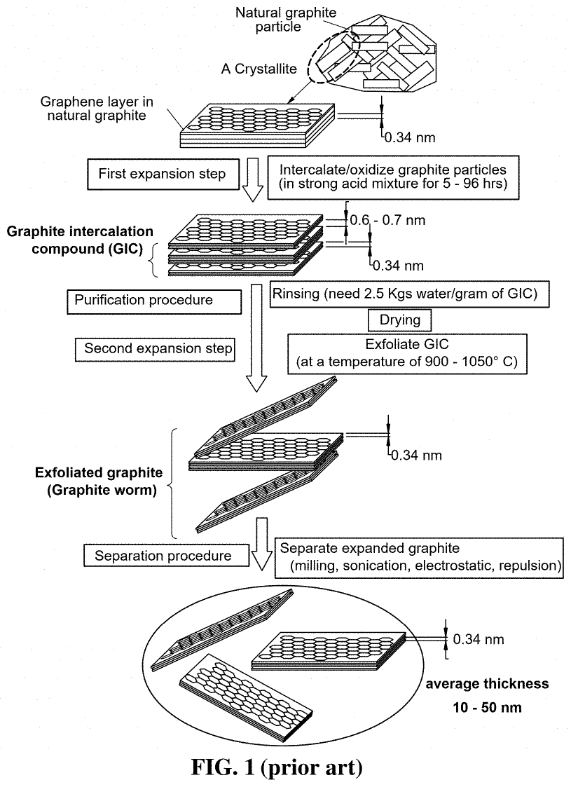

This process, as schematically illustrated in FIG. 1, entails treating natural graphite powder with an intercalant and an oxidant (e.g., concentrated sulfuric acid and nitric acid, respectively) to obtain a graphite intercalation compound (GIC) or, actually, graphite oxide (GO). [William S. Hummers, Jr., et al., Preparation of Graphitic Oxide, Journal of the American Chemical Society, 1958, p. 1339.] Prior to intercalation or oxidation, graphite has an inter-graphene plane spacing of approximately 0.335 nm (L_{d}=½d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded but un-exfoliated or exfoliated GO powder is dispersed in water or aqueous alcohol solution, which is subjected to ultrasonication. It is important to note that in these processes, ultrasonification is used after intercalation and oxidation of graphite (i.e., after first expansion) and can be after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

In the aforementioned examples, the starting material for the preparation of graphene sheets or NGPs is a graphitic material that may be selected from the group consisting of natural graphite, artificial graphite, graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof.

Graphite oxide may be prepared by dispersing or immersing a laminar graphite material (e.g., powder of natural flake graphite or synthetic graphite) in an oxidizing agent, typically a mixture of an intercalant (e.g., concentrated sulfuric acid) and an oxidant (e.g., nitric acid, hydrogen peroxide, sodium perchlorate, potassium permanganate) at a desired temperature (typically 0-70° C.) for a sufficient length of time (typically 4 hours to 5 days). The resulting graphite oxide particles are then rinsed with water several times to adjust the pH values to typically 2-5. The resulting suspension of graphite oxide particles dispersed in water is then subjected to ultrasonication to produce a dispersion of separate graphene oxide sheets dispersed in water. A small amount of reducing agent (e.g. Na₄B) may be added to obtain reduced graphene oxide (RGO) sheets.

In order to reduce the time required to produce a precursor solution or suspension, one may choose to oxidize the graphite to some extent for a shorter period of time (e.g., 30 minutes-4 hours) to obtain graphite intercalation compound (GIC). The GIC particles are then exposed to a thermal shock, preferably in a temperature range of 600-1,100° C. for typically 15 to 60 seconds to obtain exfoliated graphite or graphite worms, which are optionally (but preferably) subjected to mechanical shearing (e.g. using a mechanical shearing machine or an ultrasonicator) to break up the graphite flakes that constitute a graphite worm. Either the already separated graphene sheets (after mechanical shearing) or the un-broken graphite worms or individual graphite flakes are then re-dispersed in water, acid, or organic solvent and ultrasonicated to obtain a graphene dispersion.

The pristine graphene material is preferably produced by one of the following three processes: (A) Intercalating the graphitic material with a non-oxidizing agent, followed by a thermal or chemical exfoliation treatment in a non-oxidizing environment; (B) Subjecting the graphitic material to a supercritical fluid environment for inter-graphene layer penetration and exfoliation; or (C) Dispersing the graphitic material in a powder form to an aqueous solution containing a surfactant or dispersing agent to obtain a suspension and subjecting the suspension to direct ultrasonication to obtain a graphene dispersion.

In Procedure (A), a particularly preferred step comprises (i) intercalating the graphitic material with a non-oxidizing agent, selected from an alkali metal (e.g., potassium, sodium, lithium, or cesium), alkaline earth metal, or an alloy, mixture, or eutectic of an alkali or alkaline metal; and (ii) a chemical exfoliation treatment (e.g., by immersing potassium-intercalated graphite in ethanol solution).

In Procedure (B), a preferred step comprises immersing the graphitic material to a supercritical fluid, such as carbon dioxide (e.g., at temperature T>31° C. and pressure P>7.4 MPa) and water (e.g., at T>374° C. and P>22.1 MPa), for a period of time sufficient for inter-graphene layer penetration (tentative intercalation). This step is then followed by a sudden de-pressurization to exfoliate individual graphene layers. Other suitable supercritical fluids include methane, ethane, ethylene, hydrogen peroxide, ozone, water oxidation (water containing a high concentration of dissolved oxygen), or a mixture thereof.

In Procedure (C), a preferred step comprises (a) dispersing particles of a graphitic material in a liquid medium containing therein a surfactant or dispersing agent to obtain a suspension or slurry; and (b) exposing the suspension or slurry to ultrasonic waves (a process commonly referred to as ultrasonication) at an energy level for a sufficient length of time to produce a graphene dispersion of separated graphene sheets (non-oxidized NGPs) dispersed in a liquid medium (e.g. water, alcohol, or organic solvent).

Graphene materials can be produced with an oxygen content no greater than 25% by weight, preferably below 20% by weight, further preferably below 5%. Typically, the oxygen content is between 5% and 20% by weight. The oxygen content can be determined using chemical elemental analysis and/or X-ray photoelectron spectroscopy (XPS). When the oxygen content of graphene oxide exceeds 30% by weight (more typically when >35%), the GO molecules dispersed or dissolved in water for a GO gel state.

The laminar graphite materials used in the prior art processes for the production of the GIC, graphite oxide, and subsequently made exfoliated graphite, flexible graphite sheets, and graphene platelets were, in most cases, natural graphite. However, the present disclosure is not limited to natural graphite. The starting material may be selected from the group consisting of natural graphite, artificial graphite (e.g., highly oriented pyrolytic graphite, HOPG), graphite oxide, graphite fluoride, graphite fiber, carbon fiber, carbon nano-fiber, carbon nano-tube, mesophase carbon micro-bead (MCMB) or carbonaceous micro-sphere (CMS), soft carbon, hard carbon, and combinations thereof. All of these materials contain graphite crystallites that are composed of layers of graphene planes stacked or bonded together via van der Waals forces. In natural graphite, multiple stacks of graphene planes, with the graphene plane orientation varying from stack to stack, are clustered together. In carbon fibers, the graphene planes are usually oriented along a preferred direction. Generally speaking, soft carbons are carbonaceous materials obtained from carbonization of liquid-state, aromatic molecules. Their aromatic ring or graphene structures are more or less parallel to one another, enabling further graphitization. Hard carbons are carbonaceous materials obtained from aromatic solid materials (e.g., polymers, such as phenolic resin and polyfurfuryl alcohol). Their graphene structures are relatively randomly oriented and, hence, further graphitization is difficult to achieve even at a temperature higher than 2,500° C. But, graphene sheets do exist in these carbons.

Fluorinated graphene or graphene fluoride is herein used as an example of the halogenated graphene material group. There are two different approaches that have been followed to produce fluorinated graphene: (1) fluorination of pre-synthesized graphene: This approach entails treating graphene prepared by mechanical exfoliation or by CVD growth with fluorinating agent such as XeF₂, or F-based plasmas; (2) Exfoliation of multilayered graphite fluorides: Both mechanical exfoliation and liquid phase exfoliation of graphite fluoride can be readily accomplished [F. Karlicky, et al. “Halogenated Graphenes: Rapidly Growing Family of Graphene Derivatives” ACS Nano, 2013, 7 (8), pp 6434-6464].

Interaction of F₂ with graphite at high temperature leads to covalent graphite fluorides (CF)ₙ or (C₂F)ₙ, while at low temperatures graphite intercalation compounds (GIC) CₓF (2≤x≤24) form. In (CF)ₙ carbon atoms are sp3-hybridized and thus the fluorocarbon layers are corrugated consisting of trans-linked cyclohexane chairs. In (C₂F)ₙ only half of the C atoms are fluorinated and every pair of the adjacent carbon sheets are linked together by covalent C—C bonds. Systematic studies on the fluorination reaction showed that the resulting F/C ratio is largely dependent on the fluorination temperature, the partial pressure of the fluorine in the fluorinating gas, and physical characteristics of the graphite precursor, including the degree of graphitization, particle size, and specific surface area. In addition to fluorine (F₂), other fluorinating agents may be used, although most of the available literature involves fluorination with F₂ gas, sometimes in presence of fluorides.

For exfoliating a layered precursor material to the state of individual single graphene layers or few-layers, it is necessary to overcome the attractive forces between adjacent layers and to further stabilize the layers. This may be achieved by either covalent modification of the graphene surface by functional groups or by non-covalent modification using specific solvents, surfactants, polymers, or donor-acceptor aromatic molecules. The process of liquid phase exfoliation includes ultra-sonic treatment of a graphite fluoride in a liquid medium to produce graphene fluoride sheets dispersed in the liquid medium. The resulting dispersion can be directly used in the graphene deposition of polymer component surfaces.

The nitrogenation of graphene can be conducted by exposing a graphene material, such as graphene oxide, to ammonia at high temperatures (200-400° C.). Nitrogenated graphene could also be formed at lower temperatures by a hydrothermal method; e.g. by sealing GO and ammonia in an autoclave and then increased the temperature to 150-250° C. Other methods to synthesize nitrogen doped graphene include nitrogen plasma treatment on graphene, arc-discharge between graphite electrodes in the presence of ammonia, ammonolysis of graphene oxide under CVD conditions, and hydrothermal treatment of graphene oxide and urea at different temperatures.

For the purpose of defining the claims of the instant application, NGPs or graphene materials include discrete sheets/platelets of single-layer and multi-layer (typically less than 10 layers, the few-layer graphene) pristine graphene, graphene oxide, reduced graphene oxide (RGO), graphene fluoride, graphene chloride, graphene bromide, graphene iodide, hydrogenated graphene, nitrogenated graphene, chemically functionalized graphene, doped graphene (e.g. doped by B or N). Pristine graphene has essentially 0% oxygen. RGO typically has an oxygen content of 0.001%-5% by weight. Graphene oxide (including RGO) can have 0.001%-50% by weight of oxygen. Other than pristine graphene, all the graphene materials have 0.001%-50% by weight of non-carbon elements (e.g. O, H, N, B, F, Cl, Br, I, etc.). These materials are herein referred to as non-pristine graphene materials. The presently invented graphene can contain pristine or non-pristine graphene and the invented method allows for this flexibility. These graphene sheets all can be chemically functionalized.

As illustrated in FIG. 2(B) and FIG. 2(C), the anode of porous graphene composite balls for an alkali metal battery may be produced by a process comprising: (a) providing and dispersing multiple porous graphene composite balls and an optional binder or adhesive in a liquid medium to form a slurry; and (b) dispensing and depositing the slurry onto a surface of a current collector and removing the liquid medium to form the anode.

Illustrated in FIG. 2(C) are two series of examples on how the porous graphene composite balls (schematically illustrated in FIG. 2(A)), may be produced.

The porous graphene composite balls in Step (a) may be produced from a procedure selected from ball milling, spray drying, pan-coating, air-suspension coating, centrifugal extrusion, vibration nozzle coating, or in-situ polymerization. Step (a) of the process may then comprise a procedure of depositing a coating of an ion-conducting material onto exterior surfaces of multiple porous graphene balls to obtain the porous graphene composite balls. The procedure of depositing a coating may comprise a procedure selected from melt dipping, solution deposition, chemical vapor deposition, physical vapor deposition, sputtering, electrochemical deposition, spray coating, spray-drying, vibration nozzle coating, pan coating, air-suspension coating, plasma coating, or a combination thereof.

In certain preferred embodiments, as shown in the right-hand side of FIG. 2(C), Step (a) in the disclosed process comprises procedures of (i) producing multiple composite particles each comprising a precursor polymer and an optional carbon or graphite filler dispersed in the precursor polymer, wherein the carbon/graphite filler is selected from graphene sheets, expanded graphite flakes, carbon nanotubes, carbon nano-fibers, carbon fibers, carbon particles, graphite particles, carbon black, acetylene black, pitch, or a combination thereof; (ii) heat-treating the multiple composite particles at least at a temperature selected from 300° C. to 3,200° C. to obtain a porous carbon core for each composite particle; and (iii) encapsulating each composite particle with multiple graphene sheets before or after step (ii) or with an ion-conducting material after step (ii).

The ion-conducting material in the encapsulating shell may comprise carbon (e.g. amorphous carbon, polymeric carbon or carbonized resin, pitch, CVD carbon, etc.) and/or a lithium ion-conducting polymer selected from polydially dimethyl-ammonium chloride (PDDA), polysodium 4-styrenesulfonate (PSS), polyethylene glycol tert-octylphenylether (PEGPE), polyallyl amine (PAAm), poly(ethylene oxide) (PEO), polypropylene oxide (PPO), poly(acrylonitrile) (PAN), poly(methyl methacrylate) (PMMA), poly(vinylidene fluoride) (PVdF), poly bis-methoxy ethoxyethoxide-phosphazenex, polyvinyl chloride, polydimethylsiloxane, poly(vinylidene fluoride)-hexafluoropropylene (PVDF-HFP), a sulfonated derivative thereof, or a combination thereof.

In some embodiments, as shown in the left-hand side of FIG. 2(C), Step (a) of the process comprises the procedures of (i) encapsulating multiple particles of a sacrificial material with multiple graphene sheets to produce graphene-embraced sacrificial particles; (ii) partially or completely removing the sacrificial material from the graphene-embraced sacrificial particles to form porous graphene balls, wherein at least a porous graphene ball comprises a graphene shell encapsulating a porous core, wherein the graphene shell comprises multiple graphene sheets and the porous core comprises one or a plurality of pores; and (iii) coating, encapsulating, or impregnating the porous graphene balls with an ion-conducting material to obtain the porous graphene composite balls.

The multiple particles of sacrificial material may further contain a carbon or graphite filler selected from graphene sheets, expanded graphite flakes, carbon nanotubes, carbon nano-fibers, carbon fibers, carbon particles, graphite particles, carbon black, acetylene black, pitch, or a combination thereof. Step (ii) of removing the sacrificial material may be conducted by a procedure of (a) dissolving the sacrificial material using a solvent or water, (b) melting the sacrificial material and allowing the sacrificial material melt to flow out of the encapsulating shell, or (c) burning off the sacrificial material.

In certain preferred embodiments, Step (a) comprises procedures of (i) mixing multiple graphene sheets and an optional carbon or graphite additive with a sacrificial material to produce multiple composite particles comprising graphene sheets and the carbon or graphite additive (filler) dispersed in a matrix of the sacrificial material; (ii) partially or completely removing the sacrificial material from the composite particles to form porous graphene balls; and (iii) coating, encapsulating, or impregnating the porous graphene balls with an ion-conducting material, wherein at least a porous graphene ball comprises an ion-conducting shell encapsulating a porous core, wherein the porous core comprises multiple graphene sheets and one or a plurality of pores (possibly plus some amount of ion-conducting material). The carbon or graphite filler dispersed in the sacrificial material is selected from expanded graphite flakes, carbon nanotubes, carbon nano-fibers, carbon fibers, carbon particles, graphite particles, carbon black, acetylene black, pitch, or a combination thereof. Step (ii) of removing the sacrificial material may be conducted by a procedure of (a) dissolving the sacrificial material using a solvent or water, (b) melting the sacrificial material and allowing the sacrificial material melt to flow out of the encapsulating shell, or (c) burning off the sacrificial material.

The sacrificial material may be selected from a water-soluble polymer, an organic solvent-soluble polymer, a low-melting metal having a melting point lower than 500° C., a water-soluble material, a low-melting organic material having a melting point lower than 200° C., an inorganic material that can be dissolved in a solvent, a composite material, or a combination thereof.

The water-soluble polymer used in the process may be selected from polyvinyl alcohol, polyacrylamide (PAM), polyacrylic acid (PAA), polyamines, polyethyleneimines, polyvinylpyrrolidone (PVP), polyethylene oxide, polyethylene glycol, polypropylene oxide, polypropylene glycol, a copolymer thereof, or a combination thereof.

In certain embodiments, Step (a) of providing porous graphene composite balls comprises (i) preparing a graphene dispersion having multiple sheets of a starting graphene material dispersed in a liquid medium, wherein the starting graphene material is selected from a pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein said dispersion contains a blowing agent having a blowing agent-to-graphene material weight ratio from 0/1.0 to 1.0/1.0; (ii) dispensing, forming and drying the graphene dispersion into multiple droplets containing therein graphene sheets and the blowing agent; and (iii) heat treating the droplets at a heat treatment temperature selected from 80° C. to 3,200° C. at a desired heating rate sufficient to induce volatile gas molecules from non-carbon elements in the graphene material or to activate the blowing agent for producing multiple porous graphene balls.

In some embodiments, the process further comprises (iv) encapsulating the multiple porous graphene balls with an ion-conducting material to obtain the desired porous graphene composite balls.

In some embodiments, the graphene dispersion in sub-step (i) further comprises a polymer dissolved or dispersed in the liquid medium and the polymer-to-graphene weight ratio is from 1/100 to 100/1 and sub-step (iii) acts to converts the polymer into a carbon or graphite material.

In some embodiments, the process further comprises a sub-step (iv) of coating the multiple porous graphene balls with a thin encapsulating layer of a polymer or a polymer composite containing a carbonaceous or graphitic material dispersed in or bonded by a polymer to form polymer- or polymer composite-encapsulated porous graphene balls (the porous composite graphene balls), wherein the thin encapsulating layer has a thickness from 1 nm to 5 μm. This sub-step may be followed by a sub-step of heat-treating the polymer- or polymer composite-encapsulated porous graphene particulates to obtain carbon- or carbon composite-encapsulated porous graphene particulates.

In the disclosed process, the step of dispensing, forming and drying includes operating a procedure selected from pan-coating, air-suspension coating, centrifugal extrusion, vibration-nozzle encapsulation, spray-drying, coacervation-phase separation, interfacial polycondensation and interfacial cross-linking, in-situ polymerization, matrix polymerization, or a combination thereof.

In certain embodiments, the process further comprises a step of impregnating lithium metal or sodium metal into the anode to form lithium-preloaded or sodium-preloaded anode, wherein the lithium metal or sodium metal is preferably lodged in the pores of the composite balls.

The process may further comprise a step of incorporating the anode in a lithium metal battery, lithium-sulfur battery, lithium-selenium battery, lithium-air battery, sodium metal battery, sodium-sulfur battery, sodium-selenium battery, or sodium-air battery.

In Step (a), porous graphene balls may be obtained via several procedures. One example, as discussed above, entails spray-drying of a suspension containing multiple graphene sheets and other optional ingredients dispersed in a liquid medium (e.g. water or organic solvent).

A second example entails ball milling of a mixture containing multiple graphene sheets, a sacrificial material (e.g. sugar, salt, water-soluble polymer, etc.), and optional conducting additive. These graphene sheets can contain pristine graphene, graphene oxide, graphene fluoride, graphene chloride, graphene bromide, graphene iodide, hydrogenated graphene, nitrogenated graphene, chemically functionalized graphene, or a combination thereof. These types of isolated/separated graphene sheets (e.g. individual graphene oxide sheets have been exfoliated and isolated/separated from the precursor graphite oxide materials) can be produced via known processes.

The ball milling procedure of combining separated graphene sheets and a sacrificial material into graphene balls may be preferably conducted by using an energy impacting apparatus selected from a double cone mixer, double cone blender, vibratory ball mill, planetary ball mill, high energy mill, basket mill, agitator ball mill, cryogenic ball mill, micro ball mill, tumbler ball mill, attritor, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer. In certain preferred embodiments, the procedure of operating the energy impacting apparatus is conducted in a continuous manner using a continuous energy impacting device. The milling media may be selected from particles of a metal or metal alloy, a glass, a ceramic, a polymer, or a combination thereof.

Once ball-like structures, comprising graphene sheets and a sacrificial material, are made, the sacrificial material may be partially or totally removed to create voids inside the balls. The resulting porous graphene balls are then encapsulated with a conducting shell. Alternatively, in the cases where the sacrificial material contains a polymer, the ball-like structures may be subjected to carbonization treatments to produce porous graphene composite balls containing graphene sheets being bonded by carbon.

Additionally, there is a unique procedure for producing porous graphene balls directly from graphite without going through the production and separation of graphene sheets first. In other words, separated graphene sheets are not present prior to this unique procedure, in contrast to the procedure in the above-described procedure. This unique process comprises: (A) mixing multiple particles of a graphitic material, multiple polymer carrier particles, and an optional ball-milling media to form a mixture in an impacting chamber of an energy impacting apparatus; (B) operating the energy impacting apparatus with a frequency and an intensity for a length of time sufficient for peeling off graphene sheets from particles of the graphitic material and transferring the graphene sheets to surfaces of the polymer carrier particles to produce graphene-embraced polymer particles inside the impacting chamber; (C) recovering the graphene-embraced polymer particles from the impacting chamber; and (D) pyrolyzing the graphene-embraced polymer particles to thermally convert the polymer into pores and carbon or graphite that bonds the graphene sheets to form porous graphene composite balls, wherein at least a porous graphene ball comprises a graphene/carbon shell encapsulating a porous core and the porous core comprises one or a plurality of pores.

Again, it is important to point out that this unique procedure begins with graphite particles, not previously made isolated/separated graphene sheets. However, the ball milling apparatus can be the same. Thus, the ball milling procedure for concurrent peeling of graphene sheets from graphite particles and re-depositing of peeled-off graphene sheets on carrier particle surfaces may be preferably conducted by using an energy impacting apparatus selected from a double cone mixer, double cone blender, vibratory ball mill, planetary ball mill, high energy mill, basket mill, agitator ball mill, cryogenic ball mill, micro ball mill, tumbler ball mill, attritor, continuous ball mill, stirred ball mill, pressurized ball mill, plasma-assisted ball mill, freezer mill, vibratory sieve, bead mill, nano bead mill, ultrasonic homogenizer mill, centrifugal planetary mixer, vacuum ball mill, or resonant acoustic mixer.

There are three broad categories of methods that can be implemented to produce graphene balls (with or without other ingredients in the balls, or with or without a binder or adhesive). These include physical methods, physico-chemical methods, and chemical methods.

The physical methods include pan-coating, air-suspension coating, centrifugal extrusion, vibration nozzle coating, and spray-drying methods. The physico-chemical methods include ionotropic gelation and coacervation-phase separation methods. The chemical methods include interfacial polycondensation, interfacial cross-linking, in-situ polymerization, and matrix polymerization. Several preferred processes are briefly discussed below:

Pan-coating method: The pan coating process involves tumbling a mixture of graphene sheets and an optional conductive additive in a pan or a similar device while a bonding material or adhesive (e.g. a curable monomer/oligomer, polymer melt, polymer/solvent solution), as a sacrificial material or a carbon precursor, is applied slowly until a desired powder mass of graphene balls is attained.

Air-suspension coating method: In the air suspension coating process, a mixture of graphene sheets, an optional adhesive, and an optional conductive additive is dispersed into the supporting air stream in an encapsulating chamber. A controlled stream of a suspension comprising graphene sheets dispersed in a polymer-solvent solution (e.g. polymer or its monomer or oligomer dissolved in a solvent; or its monomer or oligomer alone in a liquid state) is concurrently introduced into this chamber, allowing the solution to hit and coat the suspended mixture particles. These suspended particles are coated with polymer/graphene sheets while the volatile solvent is removed, producing balls of polymer-bonded graphene sheets.

Vibrational nozzle encapsulation method: Graphene balls containing graphene sheets and optional conducting additive can be conducted using a laminar flow through a nozzle and vibration of the nozzle or the liquid. The vibration has to be done in resonance with the Rayleigh instability, leading to very uniform droplets. The liquid can consist of any liquids with limited viscosities (1-50,000 mPa·s): emulsions, suspensions or slurry containing the metal particles and graphene sheets dispersed in a liquid medium.

Spray-drying: Spray drying may be used to combine graphene sheets and other ingredients into graphene balls from a suspension comprising multiple graphene sheets and desired ingredients suspended in a liquid medium or a polymer solution. In spray drying, the liquid feed (solution or suspension) is atomized to form droplets which, upon contacts with hot gas, allow solvent to get vaporized and graphene sheets and other solid species naturally self-assemble into graphene balls.

The process may further comprise a step of adding 0.01% to 40% by weight of a binder, adhesive, or matrix material to help hold the multiple graphene sheets in the graphene ball together as a composite ball. This may be accomplished for example by including the adhesive/binder/matrix material in the suspension prior to the graphene ball forming procedure, or by spraying a binder or matrix material onto the surfaces of graphene balls after formation. The binder, adhesive, or matrix material may comprise an electron-conducting or lithium ion-conducting material. The electron-conducting material may be selected from an intrinsically conducting polymer, a pitch, a metal, a combination thereof, or a combination thereof with carbon. The intrinsically conducting polymer may be selected from polyaniline, polypyrrole, polythiophene, polyfuran, polyacetylene, a bi-cyclic polymer, a sulfonated derivative thereof, or a combination thereof.

The graphene balls may comprise therein a lithium ion-or sodium ion-conducting material selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

The lithium ion-conducting material may contain a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof. These salts can also be used as a lithium salt of an electrolyte for a lithium battery.

Alternatively or additionally, the lithium ion-conducting material may comprise a lithium ion-conducting polymer selected from polydially dimethyl-ammonium chloride (PDDA), polysodium 4-styrenesulfonate (PSS), polyethylene glycol tert-octylphenylether (PEGPE), polyallyl amine (PAAm), poly(ethylene oxide) (PEO), polypropylene oxide (PPO), poly(acrylonitrile) (PAN), poly(methyl methacrylate) (PMMA), poly(vinylidene fluoride) (PVdF), poly bis-methoxy ethoxyethoxide-phosphazenex, polyvinyl chloride, polydimethylsiloxane, poly(vinylidene fluoride)-hexafluoropropylene (PVDF-HFP), a sulfonated derivative thereof, or a combination thereof. These materials may be added into the suspension prior to graphene ball formation.

In certain embodiments, the graphene balls comprise therein an electron-conducting material selected from an expanded graphite flake, carbon nanotube, carbon nano-fiber, carbon fiber, carbon particle, graphite particle, carbon black, acetylene black, pitch, an electron-conducting polymer, or a combination thereof. The electron-conducting polymer is preferably selected from polyaniline, polypyrrole, polythiophene, polyfuran, polyacetylene, a bi-cyclic polymer, a sulfonated derivative thereof, or a combination thereof. These materials may be added into the suspension prior to graphene ball formation.

The process may further comprise a step of combining a cathode, the disclosed anode electrode, an optional lithium source or a sodium source in ionic contact with the anode electrode, and an electrolyte in ionic contact with both the cathode and the anode electrode to form an alkali metal battery cell. The lithium source is selected from foil, particles, or filaments of lithium metal or lithium alloy having no less than 80% by weight of lithium element in the lithium alloy; or wherein the sodium source is selected from foil, particles, or filaments of sodium metal or sodium alloy having no less than 80% by weight of sodium element in the sodium alloy. The lithium ion or sodium ion source may not be required if the cathode active material has some built-in lithium or sodium atoms (e.g. lithium transition metal oxide, NMC, NCA, etc.) that can be released during the battery charge procedure.

The graphene balls may contain single-layer or few-layer graphene sheets in the encapsulating shell, wherein the few-layer graphene sheets have 2-10 layers of stacked graphene planes having an inter-plane spacing d₀₀₂ from 0.3354 nm to 0.36 nm as measured by X-ray diffraction and the single-layer or few-layer graphene sheets contain a pristine graphene material having essentially zero % of non-carbon elements, or a non-pristine graphene material having 0.01% to 25% by weight of non-carbon elements (more typically <15%) wherein the non-pristine graphene is selected from graphene oxide, reduced graphene oxide, graphene fluoride, graphene chloride, graphene bromide, graphene iodide, hydrogenated graphene, nitrogenated graphene, chemically functionalized graphene, or a combination thereof.

The graphene balls typically have a density from 0.001 to 1.7 g/cm³, a specific surface area from 50 to 2,630 m²/g. In a preferred embodiment, the graphene sheets contain stacked graphene planes having an inter-planar spacing d₀₀₂ from 0.3354 nm to 0.40 nm as measured by X-ray diffraction.

The gaps between the free ends of the graphene sheets may be advantageously bonded by an intrinsically conducting polymer, a pitch, a metal, etc. Due to these unique chemical composition (including oxygen or fluorine content, etc.), morphology, crystal structure (including inter-graphene spacing), and structural features (e.g. degree of orientations, few defects, chemical bonding and no gap between graphene sheets, and substantially no interruptions along graphene plane directions), the graphene particulates have a unique combination of outstanding thermal conductivity, electrical conductivity, mechanical strength, and elasticity.

The aforementioned features and characteristics make a layer of multiple graphene composite balls an ideal battery anode active material for the following reasons.
1) Graphene sheets in the graphene balls bridged with a conducting material provide a network of electron-conducting pathways without interruption, allowing for low resistance to electron transport and enabling the option of reducing or eliminating the addition of an electron conductivity additive in the anode.
2) The high specific surface areas of graphene balls appear to impart dendrite formation resistance to the anode likely due to the significantly reduced electrode exchange current density.
3) The high elasticity of graphene balls (capable of deforming to a great extent when stressed and quickly recovering their original shape when the stress is relieved) enables the anode of the resulting cell to maintain the electrode dimension (e.g. without electrode thickness increase or decrease) during the battery charge or discharge. This feature is essential to maintaining structural integrity of the battery cell.

Thus, the presently invented electrodes exhibit a host of many totally unexpected advantages over the conventional lithium or sodium metal battery cell electrodes.

Electrolyte is an important ingredient in a battery. A wide range of electrolytes can be used for practicing the instant disclosure. Most preferred are non-aqueous liquid, polymer gel, and solid-state electrolytes although other types can be used. Polymer, polymer gel, and solid-state electrolytes are preferred over liquid electrolyte.

The non-aqueous electrolyte to be employed herein may be produced by dissolving an electrolytic salt in a non-aqueous solvent. Any known non-aqueous solvent which has been employed as a solvent for a lithium secondary battery can be employed. A non-aqueous solvent mainly consisting of a mixed solvent comprising ethylene carbonate (EC) and at least one kind of non-aqueous solvent whose melting point is lower than that of aforementioned ethylene carbonate and whose donor number is 18 or less (hereinafter referred to as a second solvent) may be preferably employed. This non-aqueous solvent is advantageous in that it is (a) effective in suppressing the reductive or oxidative decomposition of electrolyte; and (b) high in conductivity. A non-aqueous electrolyte solely composed of ethylene carbonate (EC) is advantageous in that it is relatively stable against carbonaceous filament materials. However, the melting point of EC is relatively high, 39 to 40° C., and the viscosity thereof is relatively high, so that the conductivity thereof is low, thus making EC alone unsuited for use as a secondary battery electrolyte to be operated at room temperature or lower. The second solvent to be used in a mixture with EC functions to make the viscosity of the solvent mixture lower than that of EC alone, thereby promoting the ion conductivity of the mixed solvent. Furthermore, when the second solvent having a donor number of 18 or less (the donor number of ethylene carbonate is 16.4) is employed, the aforementioned ethylene carbonate can be easily and selectively solvated with lithium ion, so that the reduction reaction of the second solvent with the carbonaceous material well developed in graphitization is assumed to be suppressed. Further, when the donor number of the second solvent is controlled to not more than 18, the oxidative decomposition potential to the lithium electrode can be easily increased to 4 V or more, so that it is possible to manufacture a lithium secondary battery of high voltage.

Preferable second solvents are dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene and methyl acetate (MA). These second solvents may be employed singly or in a combination of two or more. More desirably, this second solvent should be selected from those having a donor number of 16.5 or less. The viscosity of this second solvent should preferably be 28 cps or less at 25° C.

The electrolytic salts to be incorporated into a non-aqueous electrolyte may be selected from a lithium salt such as lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃) and bis-trifluoromethyl sulfonylimide lithium [LiN(CF₃SO₂)₂]. Among them, LiPF₆, LiBF₄ and LiN(CF₃SO₂)₂ are preferred. The content of aforementioned electrolytic salts in the non-aqueous solvent is preferably 0.5 to 3.5 mol/l.

For sodium metal batteries, the organic electrolyte may contain an alkali metal salt preferably selected from sodium perchlorate (NaClO₄), potassium perchlorate (KClO₄), sodium hexafluorophosphate (NaPF₆), potassium hexafluorophosphate (KPF₆), sodium borofluoride (NaBF₄), potassium borofluoride (KBF₄), sodium hexafluoroarsenide, potassium hexafluoroarsenide, sodium trifluoro-methanesulfonate (NaCF₃SO₃), potassium trifluoro-methanesulfonate (KCF₃SO₃), bis-trifluoromethyl sulfonylimide sodium (NaN(CF₃SO₂)₂), bis-trifluoromethyl sulfonylimide potassium (KN(CF₃SO₂)₂), an ionic liquid salt, or a combination thereof.

The ionic liquid is composed of ions only. Ionic liquids are low melting temperature salts that are in a molten or liquid state when above a desired temperature. For instance, a salt is considered as an ionic liquid if its melting point is below 100° C. If the melting temperature is equal to or lower than room temperature (25° C.), the salt is referred to as a room temperature ionic liquid (RTIL). The IL salts are characterized by weak interactions, due to the combination of a large cation and a charge-delocalized anion. This results in a low tendency to crystallize due to flexibility (anion) and asymmetry (cation).

A typical and well-known ionic liquid is formed by the combination of a 1-ethyl-3-methylimidazolium (EMI) cation and an N,N-bis(trifluoromethane)sulphonamide (TFSI) anion. This combination gives a fluid with an ionic conductivity comparable to many organic electrolyte solutions and a low decomposition propensity and low vapor pressure up to ˜300-400° C. This implies a generally low volatility and non-flammability and, hence, a much safer electrolyte for batteries.

Ionic liquids are basically composed of organic ions that come in an essentially unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide, and hexafluorophosphate as anions. Based on their compositions, ionic liquids come in different classes that basically include aprotic, protic and zwitterionic types, each one suitable for a specific application.

Common cations of room temperature ionic liquids (RTILs) include, but not limited to, tetraalkylammonium, di-, tri-, and tetra-alkylimidazolium, alkylpyridinium, dialkyl-pyrrolidinium, dialkylpiperidinium, tetraalkylphosphonium, and trialkylsulfonium. Common anions of RTILs include, but not limited to, BF₄⁻, B(CN)₄⁻, CH₃BF₃⁻, CH2CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)^{-, N(SO}₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte ingredient (a salt and/or a solvent) in a battery.

The cathode active material may be selected from a wide variety of oxides, such as lithium-containing nickel oxide, cobalt oxide, nickel-cobalt oxide, vanadium oxide, and lithium iron phosphate. These oxides may contain a dopant, which is typically a metal element or several metal elements. The cathode active material may also be selected from chalcogen compounds, such as titanium disulfate, molybdenum disulfate, and metal sulfides. More preferred are lithium cobalt oxide (e.g., LiₓCoO₂ where 0.8≤x≤1), lithium nickel oxide (e.g., LiNiO₂), lithium manganese oxide (e.g., LiMn₂O₄ and LiMnO₂), lithium transition metal oxides (e.g. NCM, NCA, etc.), lithium iron phosphate, lithium manganese-iron phosphate, lithium vanadium phosphate, and the like. Sulfur or lithium polysulfide may also be used in a Li—S cell.

The rechargeable lithium metal batteries can make use of non-lithiated compounds, such as TiS₂, MoS₂, MnO₂, CoO₂, V₃O₈, and V₂O₅, as the cathode active materials. The lithium vanadium oxide may be selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. In general, the inorganic material-based cathode materials may be selected from a metal carbide, metal nitride, metal boride, metal dichalcogenide, or a combination thereof. Preferably, the desired metal oxide or inorganic material is selected from an oxide, dichalcogenide, trichalcogenide, sulfide, selenide, or telluride of niobium, zirconium, molybdenum, hafnium, tantalum, tungsten, titanium, vanadium, chromium, cobalt, manganese, iron, or nickel in a nanowire, nano-disc, nano-ribbon, or nano platelet form. These materials can be in the form of a simple mixture with sheets of a graphene material, but preferably in a nano particle or nano coating form that that is physically or chemically bonded to a surface of the graphene sheets.

Preferably, the cathode active material for a sodium metal battery contains a sodium intercalation compound or a potassium intercalation compound selected from NaFePO₄, KFePO₄, Na(₁₋ₓ)KₓPO₄, Na_{0.7}FePO₄, Na_{1.5}VOPO₄F_{0.5}, Na₃V₂(PO₄)₃, Na₃V₂(PO₄)₂F₃, Na₂FePO₄F, NaFeF₃, NaVPO₄F, KVPO₄F, Na₃V₂(PO₄)₂F₃, Na_{1.5}VOPO₄F_{0.5}, Na₃V₂(PO₄)₃, NaV₆O₁₅, NaₓVO₂, Na_{0.33}V₂O₅, NaₓCoO₂, Na_{2/3}[Ni_{1/3}Mn_{2/3}]O₂, Naₓ(Fe_{1/2}Mn_{1/2})O₂, NaₓMnO₂, NaₓK₍₁₋ₓ₎MnO₂, Na_{0.44}MnO₂, Na_{0.44}MnO₂/C, Na₄Mn₉O₁₈, NaFe₂Mn(PO₄)₃, Na₂Ti₃O₇, Ni_{1/3}Mn_{1/3}Co_{1/3}O₂, Cu_{0.56}Ni_{0.44}HCF, NiHCF, NaₓMnO₂, NaCrO₂, KCrO₂, Na₃Ti₂(PO₄)₃, NiCo₂O₄, Ni₃S₂/FeS₂, Sb₂O₄, Na₄Fe(CN)₆/C, NaV₁₋ₓCrₓPO₄F, Se_{z}S_{y} (y/z=0.01 to 100), Se, Alluaudites, or a combination thereof, wherein x is from 0.1 to 1.0.

The organic material or polymeric material-based cathode materials may be selected from poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, quino(triazene), redox-active organic material, tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, hexaazatrinaphtylene (HATN), hexaazatriphenylene hexacarbonitrile (HAT(CN)₆), 5-benzylidene hydantoin, isatine lithium salt, pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, NaₓC₆O₆ (x=1-3), Na₂(C₆H₂O₄), Na₂C₈H₄O₄ (Na terephthalate), Na₂C₆H₄O₄(Na trans-trans-muconate), or a combination thereof.

The thioether polymer is selected from poly[methanetetryl-tetra(thiomethylene)] (PMTTM), poly(2,4-dithiopentanylene) (PDTP), a polymer containing poly(ethene-1,1,2,2-tetrathiol) (PETT) as a main-chain thioether polymers, a side-chain thioether polymer having a main-chain consisting of conjugating aromatic moieties, and having a thioether side chain as a pendant, poly(2-phenyl-1,3-dithiolane) (PPDT), poly(1,4-di(1,3-dithiolan-2-yl)benzene) (PDDTB), poly(tetrahydrobenzodithiophene) (PTHBDT), poly[1,2,4,5-tetrakis(propylthio) benzene] (PTKPTB, or poly[3,4(ethylenedithio)thiophene] (PEDTT).

The organic material that can be used as a cathode active material in a lithium metal battery or sodium metal battery may include a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

The following examples are used to illustrate some specific details about the best modes of practicing the instant disclosure and should not be construed as limiting the scope of the disclosure.

### EXAMPLE 1

### Production of Porous Graphene Balls (Porous Graphene Particulates) from Chemically Oxidized Flake Graphite

Graphite oxide was prepared by oxidation of graphite flakes with an oxidizer liquid consisting of sulfuric acid, sodium nitrate, and potassium permanganate at a ratio of 4:1:0.05 at 30° C. When natural graphite flakes (particle sizes of 14 μm) were immersed and dispersed in the oxidizer mixture liquid for 48 hours, the suspension or slurry appears and remains optically opaque and dark. After 48 hours, the reacting mass was rinsed with water 3 times to adjust the pH value to at least 3.0. A final amount of water was then added to prepare a series of GO-water suspensions. Approximately 1% by weight of a water-soluble polymer (PVA), based on combined GO and polymer weights, was then added into these suspensions. The mixture suspensions were then spry-dried to obtain graphene balls. Upon heating of the graphene balls at a desired temperature (typically 450-1,500° C.) for a desired length of time (typically 0.5-2.0 hours), we obtained porous graphene-carbon composite balls. A SEM image for some representative graphene balls packed together into a layer is given in FIG. 5.

In order to determine the relative stability of the porous graphene composite ball-based anode structure, the voltage profiles of symmetric layered Li-porous graphene composite ball electrode cells and the bare Li foil counterparts were obtained through over 300 cycles at nominal current density of 1 mA/cm². The porous graphene composite ball-containing layer electrode was made by the conventional slurry coating procedure using PVDF as a binder.

The symmetric layered Li-porous graphene composite ball electrode cells exhibited stable voltage profiles with negligible hysteresis, whereas the bare Li foils displayed a rapid increase in hysteresis during cycling, by 90% after less than 100 cycles. For symmetric layered Li-porous graphene composite ball electrode cells, flat voltage plateau at both the charging and discharging states can be retained throughout the whole cycle without obvious increases in hysteresis. This is a significant improvement compared with bare Li electrodes, which showed fluctuating voltage profiles with consistently higher overpotential at both the initial and final stages of each stripping/plating process. After 350 cycles, there is no sign of dendrite formation and the lithium deposition is very even in symmetric layered Li-porous graphene composite ball cells. Typically, for bare Li foil electrodes, dendrite begins to develop in less than 25 cycles.

### EXAMPLE 2

### Preparation of Single-Layer Graphene Sheets and Porous Graphene Composite Balls from Meso-Carbon Micro-Beads (MCMBs)

Meso-carbon microbeads (MCMBs) were supplied from China Steel Chemical Co., Kaohsiung, Taiwan. This material has a density of about 2.24 g/cm³ with a median particle size of about 16 μm. MCMB (10 grams) were intercalated with an acid solution (sulfuric acid, nitric acid, and potassium permanganate at a ratio of 4:1:0.05) for 48-96 hours. Upon completion of the reaction, the mixture was poured into deionized water and filtered. The intercalated MCMBs were repeatedly washed in a 5% solution of HCl to remove most of the sulfate ions. The sample was then washed repeatedly with deionized water until the pH of the filtrate was no less than 4.5. The slurry was then subjected ultrasonication for 10-100 minutes to produce GO suspensions. TEM and atomic force microscopic studies indicate that most of the GO sheets were single-layer graphene when the oxidation treatment exceeded 72 hours, and 2- or 3-layer graphene when the oxidation time was from 48 to 72 hours. The GO sheets contain oxygen proportion of approximately 35%-47% by weight for oxidation treatment periods of 48-96 hours.

The GO/water suspension was added with a small amount of polyethylene oxide or PEO (GO/PEO ratio=95/5) and then spray-dried to obtain graphene oxide/PEO balls, which were thermally reduced and carbonized at 700° C. and then 1,000° C. to obtain porous RGO/C composite balls. The RGO balls, along with a binder (SBR), were dispersed in water to form a slurry. The slurry was cast onto a surface of Cu foil to obtain a layer of porous graphene composite balls (i.e. porous RGO/C balls) bonded on the Cu foil surface.

### EXAMPLE 3

### Preparation of Porous Pristine Graphene/Polymer Composite Balls

Recognizing the possibility of the high defect population in GO sheets acting to reduce the conductivity of individual graphene plane, we decided to study if the use of pristine graphene sheets (non-oxidized and oxygen-free, non-halogenated and halogen-free, etc.) can lead to graphene balls having a higher thermal or electrical conductivity. Pristine graphene sheets were produced by using the direct ultrasonication or liquid-phase production process.

In a typical procedure, five grams of graphite flakes, ground to approximately 20 μm or less in sizes, were dispersed in 1,000 mL of deionized water (containing 0.1% by weight of a dispersing agent, Zonyl® FSO from DuPont) to obtain a suspension. An ultrasonic energy level of 85 W (Branson S450 Ultrasonicator) was used for exfoliation, separation, and size reduction of graphene sheets for a period of 15 minutes to 2 hours. The resulting graphene sheets are pristine graphene that have never been oxidized and are oxygen-free and relatively defect-free. There are substantially no other non-carbon elements.

The graphene-water suspension was then mixed with a solution that contained PEDOT/PSS dissolved in water to make a slurry. It may be noted that Poly(3,4-ethylenedioxythiophene): polystyrene sulfonate (PEDOT:PSS) is a polymer mixture of two ionomers. One component is made up of sodium polystyrene sulfonate, which is a sulfonated polystyrene. Part of the sulfonyl groups are deprotonated and carry a negative charge. The other component poly(3,4-ethylenedioxythiophene) or PEDOT is a conjugated polymer, polythiophene, which carries positive charges. Together the two charged polymers form a macromolecular salt, which is soluble in water. The slurry was then spray-dried to obtain porous graphene balls having graphene sheets bonded by PEDOT/PSS.

A layer of active materials (porous graphene composite balls) was deposited onto a Cu foil-based current collector as an anode in sodium-ion batteries. Electrochemical characterization was conducted by using CR2032-type coin cell wherein Na metal was used as the counter and reference electrodes. To make an anode, active material (porous graphene composite balls, 85 wt %), Super P (conductive additive; 7 wt %) and PAA binder (8 wt %) were mixed in mortal and then N-methyl-2-pyrrolidone (NMP) was added to prepare a slurry. The slurry was casted on Cu foil and dried in a vacuum oven at 150° C. for 10 h. Disc-shape electrodes were punched into 12 mm size. The average loading mass of electrodes was 3.2 mg/cm². Further, 1 M solution of NaPF6 in ethylene carbonate (EC) and diethyl carbonate (DEC) (1:1, v/v) with 5% flouro-ethylene carbonate (FEC) was employed as an electrolyte, and glass fiber fabric was used as a porous separator. The coin cell was fabricated in an Ar-filled glove box. Galvanostatic charge-discharge cycling test was performed between 0.01 and 2 V vs. Na⁺/Na at various rates or current densities (0.1 to 2 A/g).

### EXAMPLE 4

### Preparation of Porous Graphene Composite Balls from Graphene Fluoride

Several processes have been used by us to produce GF, but only one process is herein described as an example. In a typical procedure, highly exfoliated graphite (HEG) was prepared from intercalated compound C₂F·xClF₃. HEG was further fluorinated by vapors of chlorine trifluoride to yield fluorinated highly exfoliated graphite (FHEG). Pre-cooled Teflon reactor was filled with 20-30 mL of liquid pre-cooled ClF₃, the reactor was closed and cooled to liquid nitrogen temperature. Then, no more than 1 g of HEG was put in a container with holes for ClF₃ gas to access and situated inside the reactor. In 7-10 days a gray-beige product with approximate formula C₂F was formed.

Subsequently, a small amount of FHEG (approximately 0.5 mg) was mixed with 20-30 mL of an organic solvent (methanol, but ethanol, 1-propanol, 2-propanol, 1-butanol, tert-butanol, isoamyl alcohol all can be used) and subjected to an ultrasound treatment (280 W) for 30 min, leading to the formation of homogeneous yellowish dispersion. The dispersion was ultrasonic-sprayed into hot water to obtain porous graphene balls. Porous graphene composite balls were prepared via a solution phase synthesis by mixing porous graphene balls with phytic acid and aniline in water to give a suspension. Within 5 min upon addition of an oxidizer (e.g. ammonium persulfate), the aniline was rapidly polymerized and crosslinked, resulting in a dark green viscous gel due to the presence of the phytic acid gelator. The viscous gel was then cast onto a copper foil current collector and dried to form a uniform anode layer (containing polyaniline-encapsulated porous graphene balls) for use in a lithium metal battery.

### EXAMPLE 5

### Preparation of Porous Graphene Composite Balls from Nitrogenated Graphene

Graphene oxide (GO), synthesized in Example 1, was finely ground with different proportions of urea and the pelletized mixture heated in a microwave reactor (900 W) for 30 s. The product was washed several times with deionized water and vacuum dried. In this method graphene oxide gets simultaneously reduced and doped with nitrogen. The products obtained have nitrogen contents of 14.7, 18.2 and 17.5 wt % respectively as measured by elemental analysis. These nitrogenated graphene sheets remain dispersible in water. Subsequently, 10% by weight of glucose was dissolved in the nitrogenated graphene-water dispersion. The resulting suspensions were then spray-dried to obtain graphene/sugar balls, which were then carbonized in 350-650° C. to produce porous graphene/carbon composite balls.

The porous graphene composite balls, along with CMC binder, were dispersed in water to make a slurry, which was cast onto a Cu foil surface to make a layer of porous graphene composite balls. Water was then removed from the structure to obtain an anode.

### EXAMPLE 6

### Evaluation of Various Lithium Metal and Sodium Metal Cells

In a conventional cell, an electrode (e.g. cathode) is typically composed of 85% of an electrode active material (e.g. LiₓV₂O₅, NCM, NCA, sodium polysulfide, lithium polysulfide, etc.), 5% Super-P (acetylene black-based conductive additive), and 10% PTFE, which were mixed in NMP solvent to form a slurry. The slurry was then coated on Al foil. The thickness of electrode was around 50-150 μm. A wide variety of cathode active materials were implemented to produce lithium metal batteries and sodium metal batteries. Anode layers were similarly made using multiple porous graphene composite balls as an anode layer as decribed in the above 5 examples.

For each sample, both coin-size and pouch cells were assembled in a glove box. The charge storage capacity was measured with galvanostatic experiments using an Arbin SCTS electrochemical testing instrument. Cyclic voltammetry (CV) and electrochemical impedance spectroscopy (EIS) were conducted on an electrochemical workstation (CHI 660 System, USA).

For each sample, several current density (representing charge/discharge rates) were imposed to determine the electrochemical responses, allowing for calculations of energy density and power density values required of the construction of a Ragone plot (power density vs. energy density).

Some data on the gravimetric power density vs. energy density of two sets of lithium metal cells were obtained: (a) first cell containing porous nitrogenated graphene composite balls bonded by PVDF, in physical contact with a lithium foil, as the anode active material; (b) the second cell containing no porous graphene composite balls. These data indicate that the energy density and power density ranges of these two cells are comparable. However, SEM examination of the cell samples, taken after 30 charge-discharge cycles, indicates that the sample containing porous graphene composite balls has essentially all the lithium ions returning from the cathode during charge being uniformly distributed inside pores of the porous graphene composite balls, having no tendency to form lithium dendrites. In some cases, smooth lithium metal layer was deposited on the current collector surface underneath the graphene composite ball layer. In contrast, for the cell containing no porous graphene composite balls, lithium metal tends to get re-plated on the current collector in a less uniform manner. Further surprisingly, the cell comprising porous graphene composite balls exhibits a more stable cycling behavior.

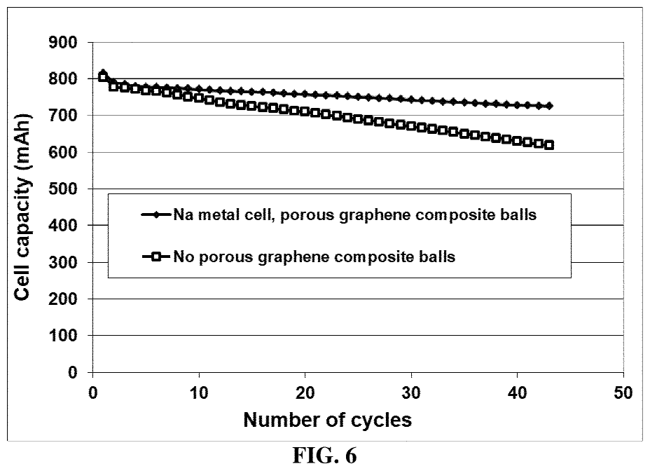

Shown in FIG. 6 are battery cell capacity decay curves of two sodium metal cells. One cell contains a layer of porous pristine graphene composite balls and a sheet of Na foil as the anode active material, and NaFePO₄ as the cathode active material. For comparison, a sodium metal cell containing a Cu foil at the anode (but no porous graphene composite balls) and a sheet of Na foil coated on the Cu foil as the anode active material is also investigated. The cell having porous graphene composite balls shows a significantly more stable cycling behavior.

In conclusion, we have successfully developed a new, novel, unexpected, and patently distinct class of porous graphene composite balls or particulates that can be used in a lithium metal battery or sodium metal battery for overcoming the dendrite issues. This class of new materials has now made it possible to use lithium metal and sodium metal batteries that have much higher energy densities as compared to the conventional lithium-ion cells. Additionally, the graphene particulates, preloaded with lithium or sodium, may be used as a pre-lithiating agent or pre-sodiating agent for a conventional lithium-ion battery or sodium-ion battery, respectively.

1. An anode for a lithium battery or sodium battery, said anode comprising multiple porous graphene composite balls, wherein said porous graphene composite ball comprises a plurality of graphene sheets and an ion-conducting material, at a graphene-to-ion-conducting material weight ratio from 2/98 to 98/2, that are combined to form into said composite ball having a diameter from 50 nm to 20 μm and a pore or multiple pores having a pore volume fraction from 10% to 99.9% based on the total porous graphene composite ball volume.

2. The anode of claim 1, wherein said ion-conducting material comprises carbon and said multiple porous graphene composite balls comprise a graphene/carbon ball comprising a plurality of graphene sheets and a carbon phase that are combined to form into a ball shape.

3. The anode of claim 1, wherein said ion-conducting material comprises a lithium ion-conducting material selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, 0<x≤1, 1≤y≤4.

4. The anode of claim 1, wherein said ion-conducting material contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

5. The anode of claim 1, wherein said ion-conducting material comprises a lithium ion-conducting polymer selected from polydially dimethyl-ammonium chloride (PDDA), polysodium 4-styrenesulfonate (PSS), polyethylene glycol tert-octylphenylether (PEGPE), polyallyl amine (PAAm), poly(ethylene oxide) (PEO), polypropylene oxide (PPO), poly(acrylonitrile) (PAN), poly(methyl methacrylate) (PMMA), poly(vinylidene fluoride) (PVdF), poly bis-methoxy ethoxyethoxide-phosphazenex, polyvinyl chloride, polydimethylsiloxane, poly(vinylidene fluoride)-hexafluoropropylene (PVDF-HFP), a sulfonated derivative thereof, or a combination thereof.

6. The anode of claim 1, wherein said ion-conducting material comprises a sulfonated polymer.

7. The anode of claim 1, further comprising a current collector having two primary surfaces, wherein said multiple porous graphene composite balls form at least an anode active material layer that is deposited on one or two primary surfaces of the current collector.

8. The anode of claim 7, wherein said anode active material layer further comprises a binder that bonds the multiple porous graphene composite balls together.

9. The anode of claim 1, wherein said graphene sheets contain single-layer or few-layer graphene, wherein said few-layer graphene sheets have 2-10 layers of stacked graphene planes having an inter-plane spacing d₀₀₂ from 0.3354 nm to 0.6 nm as measured by X-ray diffraction and said single-layer or few-layer graphene sheets contain a pristine graphene material having essentially zero % of non-carbon elements, or a non-pristine graphene material having 0.001% to 25% by weight of non-carbon elements.

10. The anode of claim 9, wherein said non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

11. The anode of claim 2, wherein said graphene/carbon ball comprises 0.01% to 40% by weight of carbon that holds said multiple graphene sheets together as a porous composite graphene/carbon ball.

12. The anode of claim 2, wherein said graphene/carbon ball comprises a layer of carbon that encapsulates said ball and forms an exterior surface of said ball.

13. The anode of claim 12, wherein said exterior surface further comprises a lithium ion-conducting material or sodium ion-conducting material dispersed in or coated on said layer of carbon.

14. The anode of claim 1, wherein said graphene composite ball comprises said graphene sheets that are encapsulated by a thin layer of said ion-conducting material having a thickness from 1 nm to 5 μm.

15. The anode of claim 1, wherein said graphene composite balls further contain therein an electron-conducting material selected from an expanded graphite flake, carbon nanotube, carbon nano-fiber, carbon fiber, carbon particle, graphite particle, carbon black, acetylene black, pitch, or a combination thereof.

16. The anode of claim 1, wherein the anode further comprises lithium metal or sodium metal residing in said pores to form a lithium-preloaded or sodium-preloaded graphene composite particulate.

17. The anode of claim 1, wherein said porous graphene composite ball has a density from 0.005 to 1.7 g/cm³ and a specific surface area from 50 to 2,630 m²/g.

18. An alkali metal battery comprising a cathode, the anode of claim 1, an optional lithium source or an optional sodium source in ionic contact with said anode, and an electrolyte in ionic contact with both said cathode and said anode.

19. The alkali metal battery of claim 18, wherein said lithium source is selected from foil, particles, or filaments of lithium metal or lithium alloy having no less than 80% by weight of lithium element in said lithium alloy; or wherein said sodium source is selected from foil, particles, or filaments of sodium metal or sodium alloy having no less than 80% by weight of sodium element in said sodium alloy.

20. The alkali metal battery of claim 18, which is a lithium metal battery, lithium-sulfur battery, lithium-selenium battery, lithium-air battery, sodium metal battery, sodium-sulfur battery, sodium-selenium battery, or sodium-air battery.

21. A lithium-ion battery comprising the anode of claim 1, a cathode, an electrolyte in ionic contact with said anode and said cathode, wherein said cathode comprises a lithium-containing cathode active material that releases lithium ions into said electrolyte when the battery is charged and the released lithium ions move to the anode.

22. A sodium-ion battery comprising the anode of claim 1, a cathode, an electrolyte in ionic contact with said anode and said cathode, wherein said cathode comprises a sodium-containing cathode active material that releases sodium ions into said electrolyte when the battery is charged and the released sodium ions move to the anode.

23. A process for producing the anode of claim 1, the process comprising: (a) providing and dispersing multiple porous graphene composite balls and an optional binder or adhesive in a liquid medium to form a slurry; and (b) dispensing and depositing the slurry onto a surface of a current collector and removing the liquid medium to form the anode.

24. The process of claim 23, wherein Step (a) of providing comprises a procedure of depositing a coating of an ion-conducting material onto exterior surfaces of multiple porous graphene balls to obtain the porous graphene composite balls.

25. The process of claim 24, wherein the procedure of depositing a coating comprises a procedure selected from melt dipping, solution deposition, chemical vapor deposition, physical vapor deposition, sputtering, electrochemical deposition, spray coating, spray-drying, vibration nozzle coating, pan coating, air-suspension coating, plasma coating, or a combination thereof.

26. The process of claim 23, wherein the porous graphene composite balls in Step (a) are produced from a procedure selected from ball milling, spray drying, pan-coating, air-suspension coating, centrifugal extrusion, vibration nozzle coating, or in-situ polymerization.

27. The process of claim 23, wherein Step (a) comprises procedures of (i) producing multiple composite particles each comprising a precursor polymer and an optional carbon or graphite filler dispersed in the precursor polymer, wherein the filler is selected from graphene sheets, expanded graphite flakes, carbon nanotubes, carbon nano-fibers, carbon fibers, carbon particles, graphite particles, carbon black, acetylene black, pitch, or a combination thereof; (ii) heat-treating the multiple composite particles at least at a temperature selected from 300° C. to 3,200° C. to obtain a porous carbon core for each composite particle; and (iii) encapsulating each composite particle with multiple graphene sheets before or after step (ii) or with an ion-conducting material after step (ii).

28. The process of claim 23, wherein Step (a) comprises procedures of (i) encapsulating multiple particles of a sacrificial material with multiple graphene sheets to produce graphene-embraced sacrificial particles; (ii) partially or completely removing the sacrificial material from the graphene-embraced sacrificial particles to form porous graphene balls, wherein at least a porous graphene ball comprises a graphene shell encapsulating a porous core, wherein said graphene shell comprises multiple graphene sheets and the porous core comprises one or a plurality of pores; and (iii) coating, encapsulating, or impregnating the porous graphene balls with an ion-conducting material to obtain the porous graphene composite balls.

29. The process of claim 23, wherein Step (a) comprises procedures of (i) mixing multiple graphene sheets and an optional carbon or graphite additive with a sacrificial material to produce multiple composite particles comprising graphene sheets and the carbon or graphite additive dispersed in a matrix of the sacrificial material; (ii) partially or completely removing the sacrificial material from the composite particles to form porous graphene balls; and (iii) coating, encapsulating, or impregnating the porous graphene balls with an ion-conducting material, wherein at least a porous graphene ball comprises an ion-conducting shell encapsulating a porous core, wherein the porous core comprises multiple graphene sheets and one or a plurality of pores.

30. The process of claim 28, wherein the multiple particles of a sacrificial material comprises a carbon or graphite additive dispersed therein and the carbon or graphite additive is selected from graphene sheets, expanded graphite flakes, carbon nanotubes, carbon nano-fibers, carbon fibers, carbon particles, graphite particles, carbon black, acetylene black, pitch, or a combination thereof.

31. The process of claim 29, wherein the carbon or graphite additive dispersed in the sacrificial material is selected from expanded graphite flakes, carbon nanotubes, carbon nano-fibers, carbon fibers, carbon particles, graphite particles, carbon black, acetylene black, pitch, or a combination thereof.

32. The process of claim 28, wherein step (ii) of removing said sacrificial material is conducted by a procedure of (a) dissolving the sacrificial material using a solvent or water, (b) melting the sacrificial material and allowing the sacrificial material melt to flow out of the encapsulating shell, or (c) burning off the sacrificial material.

33. The process of claim 29, wherein step (ii) of removing said sacrificial material is conducted by a procedure of (a) dissolving the sacrificial material using a solvent or water, (b) melting the sacrificial material and allowing the sacrificial material melt to flow out of the encapsulating shell, or (c) burning off the sacrificial material.

34. The process of claim 28, wherein the sacrificial material is selected from a water-soluble polymer, an organic solvent soluble polymer, a low-melting metal having a melting point lower than 500° C., a water-soluble material, a low-melting organic material having a melting point lower than 200° C., an inorganic material that can be dissolved in a solvent, a composite material, or a combination thereof.

35. The process of claim 29, wherein the sacrificial material is selected from a water-soluble polymer, an organic solvent soluble polymer, a low-melting metal having a melting point lower than 500° C., a water-soluble material, a low-melting organic material having a melting point lower than 200° C., an inorganic material that can be dissolved in a solvent, a composite material, or a combination thereof.

36. The process of claim 34, wherein said water-soluble polymer is selected from polyvinyl alcohol, polyacrylamide (PAM), polyacrylic acid (PAA), polyamines, polyethyleneimines, polyvinylpyrrolidone (PVP), polyethylene oxide, polyethylene glycol, polypropylene oxide, polypropylene glycol, a copolymer thereof, or a combination thereof.

37. The process of claim 23, wherein Step (a) comprises (i) preparing a graphene dispersion having multiple sheets of a starting graphene material dispersed in a liquid medium, wherein said starting graphene material is selected from a pristine graphene, graphene oxide, reduced graphene oxide, graphene fluoride, graphene chloride, graphene bromide, graphene iodide, hydrogenated graphene, nitrogenated graphene, chemically functionalized graphene, or a combination thereof and wherein said dispersion contains a blowing agent having a blowing agent-to-graphene material weight ratio from 0/1.0 to 1.0/1.0; (ii) dispensing, forming and drying said graphene dispersion into multiple droplets containing therein graphene sheets and said blowing agent; and (iii) heat treating the droplets at a heat treatment temperature selected from 80° C. to 3,200° C. at a desired heating rate sufficient to induce volatile gas molecules from non-carbon elements in said graphene material or to activate said blowing agent for producing said multiple porous graphene balls.

38. The process of claim 37, wherein the process further comprises encapsulating the multiple porous graphene balls with an ion-conducting material.

39. The process of claim 37, wherein said dispersion further comprises a polymer dissolved or dispersed in said liquid medium and the polymer-to-graphene weight ratio is from 1/100 to 100/1.

40. The process of claim 37, further comprising a step of coating said multiple porous graphene balls with a thin encapsulating layer of a polymer or a polymer composite containing a carbonaceous or graphitic material dispersed in or bonded by a polymer to form polymer- or polymer composite-encapsulated porous graphene balls, wherein the thin encapsulating layer has a thickness from 1 nm to 5 μm.

41. The process of claim 40, further comprising a step of heat-treating said polymer- or polymer composite-encapsulated porous graphene particulates to obtain carbon- or carbon composite-encapsulated porous graphene particulates.

42. The process of claim 37, wherein said step of dispensing, forming and drying includes operating a procedure selected from pan-coating, air-suspension coating, centrifugal extrusion, vibration-nozzle encapsulation, spray-drying, coacervation-phase separation, interfacial polycondensation and interfacial cross-linking, in-situ polymerization, matrix polymerization, or a combination thereof.

43. The process of claim 23, wherein the process further comprises a step of impregnating lithium metal or sodium metal into the anode to form lithium-preloaded or sodium-preloaded anode.

44. The process of claim 23, wherein the process further comprises a step of incorporating the anode in a lithium metal battery, lithium-sulfur battery, lithium-selenium battery, lithium-air battery, sodium metal battery, sodium-sulfur battery, sodium-selenium battery, or sodium-air battery.

45. The process of claim 23, wherein the multiple porous graphene composite balls are produced by procedures comprising (A) mixing multiple particles of a graphitic material, multiple polymer carrier particles, and an optional ball-milling media to form a mixture in an impacting chamber of an energy impacting apparatus; (B) operating the energy impacting apparatus with a frequency and an intensity for a length of time sufficient for peeling off graphene sheets from particles of the graphitic material and transferring the graphene sheets to surfaces of the polymer carrier particles to produce graphene-embraced polymer particles inside the impacting chamber; (C) recovering the graphene-embraced polymer particles from the impacting chamber; and (D) pyrolyzing the graphene-embraced polymer particles to thermally convert the polymer into pores and carbon or graphite that bonds the graphene sheets to form porous graphene composite balls, wherein at least a porous graphene ball comprises a graphene/carbon shell encapsulating a porous core and the porous core comprises one or a plurality of pores.
